(19) United States
(12) Patent Application Publication
(10) Pub. No.: US 2007/0032887 A1
(43) Pub. Date: Feb. 8, 2007

(54) Information management system, information processing device, and program

(75) Inventors: Kazushige Muroi, Nagoya-shi (JP); Satoru Yanagi, Nagoya-shi (JP); Satoshi Watanabe, Kasugai-shi (JP); Kazuma Aoki, Kasugai-shi (JP)

Correspondence Address: MCDERMOTT WILL & EMERY LLP, 600 13TH STREET, N.W., WASHINGTON, DC, 20005-3096, US

(73) Assignee: Brother Kogyo Kabushiki Kaisha

(21) Appl. No.: 11/492,787

(22) Filed: Jul. 26, 2006

(30) Foreign Application Priority Data
Jul. 26, 2005 (JP) P2005-215943
Jul. 26, 2005 (JP) P2005-215944

(51) Int. Cl. G06T 1/00; G06F 13/00; G06F 13/372; G09G 1/02; G05B 11/01; G05B 19/42; G05B 13/02

(52) U.S. Cl. 700/19; 345/27; 345/501; 700/18; 700/29; 700/14; 700/86

(57) ABSTRACT

In an information management system comprising: an external apparatus having a function executing unit which includes input unit; and an information processing apparatus connected to the external apparatus, when another reading process operation different from one reading process operation executed by the input unit is specified, a specific time specified by one time instant contained in a time period corresponding to the execution of the one reading process operation and another time instant corresponding to the execution of another reading process operation, and a predetermined condition time are compared with each other; and in the case that the specific time is shorter than or equal to the condition time, a relationship is applied to both data obtained by the above-described one reading process operation and data obtained by the above-described another reading process operation, while it is so assumed that these data are related to each other.

### CROSS REFERENCE TO RELATED APPLICATION

This application claims priority from Japanese Patent Applications Nos. 2005-215943 and 2005-215944, filed Jul. 26, 2005, the contents of which are hereby incorporated by reference into the present application.

### TECHNICAL FIELD

Aspects of the present invention relate to an information management system for managing information or data, an information processing device of the information management system, and a program thereof.

### BACKGROUND

In recent years, personal computers (hereinafter, referred to as “PC”) have been widely used for a personal purpose or on business. For example, a PC is connected to an external device serving as an information input source or an external device for processing based on a command from the PC. Specifically, the PC receives data from the external devices and uses the information for management, while the processes based on the managed information are performed to the external device. When it is difficult to install a plurality of external devices, a multifunction machine comprising a plurality of units that execute a plurality of functions is connected to the PC.

The PC and the external device transmit and receive a large amount of information therebetween depending upon operations of the external device. The PC manages the large amount of information (for example, see JP-A-2004-32085).

In the PC for managing a large amount of data, there have been suggested techniques of correlating data so as to enhance an efficiency for data processing.

For example, there is known an information management system, which displays a message requesting for inputting instruction of correlating conditions, receives an instruction from a user in response to the display and perform the correlating operation, so as to correlate the data to be written with the relevant data at the time of writing data (for example, see JP-A-2000-315203).

An aspect of the present invention provides an information management system capable of classifying data which provide relevance based upon reading process executed serially at the same time or continuously by an input section of an external apparatus, and capable of managing the classified data. Another aspect of the present invention provides an information processing apparatus included in the above information management system, and a program for executing operation of the information processing apparatus.

### SUMMARY

According to an aspect of the present invention, an information management system comprises: an external device having a function performing unit that includes an input unit; and an information processing device connected to the external device. The information processing device comprises: a detection unit that detects a period in which the function performing unit of the external device performs a process; a specification unit that specifies that the process performed in the period detected by the detection unit corresponds to a reading process of data by the input unit; a storage unit that correlates and stores the period in which the reading process specified by the specification unit is performed and the data read in the period, and that stores a condition time to relate the data read by the input unit with each other; a comparing unit that compares (1) a specific time specified by (11) one time instant included in the period and corresponding to execution of one reading process specified by the specification unit and (12) another time instant included in the period and corresponding to the execution of another reading process different from the one reading process, with (2) the condition time stored in the storage unit, in case where the another reading process is specified by the specification unit; and a correlation giving unit that gives a correlation that (1′) the one reading process or data obtained by the one reading process is correlated with (2′) data obtained by the another reading process, in a case where the specific time is shorter than or equal to the condition time. The external device comprises an offer unit that offers the period and information that specifies the process performed in the period in a state where the information processing device detects the process, in a case where the process is performed by the function performing unit.

### BRIEF DESCRIPTION OF THE DRAWINGS

FIG. 1 is a diagram illustrating an information management system according to an illustrative aspect of the invention;

FIG. 2 is a diagram illustrating a status table according to the illustrative aspect of the invention;

FIG. 3 is a diagram illustrating definitions of items stored in the status table according to the illustrative aspect of the invention;

FIG. 4 is a diagram illustrating a document table according to the illustrative aspect of the invention;

FIG. 5 is a diagram illustrating a file information table according to the illustrative aspect of the invention;

FIG. 6 is a diagram illustrating a device designating table according to the illustrative aspect of the invention;

FIG. 7 is a diagram illustrating a flow of a main process performed by a PC according to the illustrative aspect of the invention;

FIG. 8 is a diagram illustrating a flow of a before-activation intellectual assistance process according to the illustrative aspect of the invention;

FIG. 9 is a diagram illustrating a flow of an event document search process according to the illustrative aspect of the invention;

FIGS. 10A, 10B, and 10C are diagrams illustrating a display format resulting from the before-activation intellectual assistance process according to the invention;

FIG. 11 is a diagram illustrating a flow of a during-activation intellectual assistance process according to the illustrative aspect of the invention;

FIG. 12 is a diagram illustrating a flow of a GID search condition setting process according to the illustrative aspect of the invention;

FIG. 13 is a diagram illustrating a flow of a document search process according to the illustrative aspect of the invention;

FIG. 14 is a diagram illustrating a flow of a search result display process according to the illustrative aspect of the invention;

FIG. 15 is a diagram illustrating a display format (associated with the status table (whole)) of a search result in the during-activation intellectual assistance process according to the illustrative aspect of the invention;

FIG. 16 is a diagram illustrating a display format (associated with the document table) of a search result in the during-activation intellectual assistance process according to the illustrative aspect of the invention;

FIG. 17 is a diagram illustrating a display format (associated with the status table (whole)) of a search result in the during-activation intellectual assistance process according to the illustrative aspect of the invention;

FIG. 18 is a diagram illustrating a display format (associated with the document table) of a search result in the during-activation intellectual assistance process according to the illustrative aspect of the invention;

FIG. 19 is a diagram illustrating a flow of a status table registration process according to the illustrative aspect of the invention;

FIG. 20 is a diagram illustrating a flow of a manual intellectual assistance process according to the illustrative aspect of the invention;

FIG. 21 is a diagram illustrating a flow of the manual intellectual assistance process according to the illustrative aspect of the invention;

FIG. 22 is a diagram illustrating a flow of a document intellectual assistance process according to the illustrative aspect of the invention;

FIG. 23 is a diagram illustrating a display format (associated with the status table) of a search result in the manual intellectual assistance process according to the illustrative aspect of the invention;

FIG. 24 is a diagram illustrating a display format (associated with the document table) of a search result in the manual intellectual assistance process according to the illustrative aspect of the invention;

FIG. 25 is a diagram illustrating a flow of a document table updating process according to the illustrative aspect of the invention;

FIG. 26 is a diagram illustrating flow operations as to a scanning search process according to the illustrative aspect of the invention;

FIG. 27A and FIG. 27B are diagrams for representing degrees (weights) of relevance according to the illustrative aspect of the invention;

FIG. 28 is a diagram illustrating a search result table according to the illustrative aspect of the invention; and

FIG. 29 is a diagram illustrating a flow of the during-activation intellectual assistance process according to the illustrative aspect of the invention;

### DETAILED DESCRIPTION

General Overview

As a consequence, each data, which is read by the input section of the external apparatus serially at the same time or continuously for one purpose, can be correlated with the reading process.

“Time period” in either the first time period or the second time period includes a time point element. In this case, one time point included in the time period is identical to this time period.

An information management system, according to Claim 2, is featured by that in the information management system recited in Claim 1, in such a case that 3, or more data are related to each other, the relationship applying unit compares one time instant contained in the time period corresponding to an execution of a reading process with respect to one data among the related data with specific times specified by other time instants contained in the time period corresponding to executions of reading process with respect to remaining data, and applies a relationship of a high degree with respect to such a data mutual relationship that the specific times become short.

As a consequence, degree of relevance to one data can be applied to each of other data relevant to a reading process or one data read by the reading process for one purpose.

An information management system, according to Claim 3, is featured by that in the information management system recited in Claim 2, the information processing apparatus is comprised of: output unit for outputting information which specifies the data related by the relationship applying unit; and output control unit operated in such a manner that when the information for specifying the related data is outputted to the output unit, the output control unit controls the relationship applying unit to output data in a top priority, to which the high degree relationship has been applied.

As a consequence, information, which specifies other data highly relevant to the reading process or one data read by the reading process, can be sequentially notified to the user.

An information management system, according to Claim 4 of the present invention, is featured by such an information management system comprising: an external apparatus equipped with one, or a plurality of function executing unit which includes input unit; and an information processing apparatus connected to the external apparatus in a communicable manner; wherein: the information processing apparatus is comprised of: detecting unit for detecting a time period during which a process is executed by the function executing unit of the external apparatus; first specifying unit for specifying that the process executed in the time period detected by the detecting unit corresponds to a data reading process by the input unit; storage unit for storing thereinto the time period during which the reading process specified by the specifying unit was executed and the read data in the time period in relation to each other, and for storing thereinto such a condition relationship that while times used to acquire relative degrees of the respective data read by the input unit are defined as elements, the condition relationship is determined with a relationship in which the degrees are decreased with respect to an increase of lengths of the times, and also for storing thereinto condition degrees which are employed so as to relate the respective data to each other which are read by the input unit; weight acquiring unit operated in such a manner that in the case that another reading process different from one reading process specified by the first specifying unit is specified by the first specifying unit, while both one time instant contained in the time period corresponding to the execution of the one reading process, and a specific time specified by another time point contained in the time period corresponding to the execution of the another reading process are employed as a condition, the weight acquiring unit acquires a weight for evaluating a relative degree from the condition relationship stored in the storage unit; comparing unit for comparing the weight acquired by the weight acquiring unit with the condition weight stored in the storage unit; and relationship applying unit operated in such a manner that in the case that the weight acquired by the weight acquiring unit is higher than the condition weight, or the weight acquired by the weight acquiring unit is higher than, or equal to the condition weight as a comparison result of the comparing unit, the relationship applying unit applies a relationship to both data obtained by the one reading process and data obtained by the another reading process, while it is so assumed that the data are related to each other; and wherein: the external apparatus is comprised of: providing unit for providing both the time period and information for specifying the process executed in the time period when the process is executed by the function executing unit under detectable condition by the information processing apparatus.

As a consequence, each data, which is read by the input section of the external apparatus serially at the same time or continuously for one purpose, can be correlated with the reading process.

An information processing apparatus, according to Claim 5 of the present invention, is featured by such an information processing apparatus connected to an external apparatus in a communicable manner, which is comprised of: one, or a plurality of executing unit containing input unit; and providing unit operated in such a manner that when a process was executed by the function executing unit, under detectable condition, the providing unit provides both a time period during which the process was executed, and information for specifying the process executed in the time period; wherein: the information processing apparatus is comprised of: detecting unit for detecting the time period; specifying unit for specifying that the process executed in the time period detected by the detecting unit corresponds to a data reading process by the input unit; storage unit for storing thereinto the time period during which the reading process specified by the specifying unit was executed and the read data in the time period in relation to each other, and for storing thereinto a condition time which is employed so as to relate the respective data read by the input unit with each other; comparing unit operated in such a manner that when another reading process different from one reading process specified by the specifying unit is specified by the specifying unit, the comparing unit compares one time instant contained in the time period corresponding to the execution of the one reading process, a specific time specified by another time point contained in the time period corresponding to the execution of the another reading process, and the condition time stored in the storage unit with each other; and relationship applying unit operated in such a manner that in the case that the specific time is shorter than the condition time, or the specific time is shorter than, or equal to the condition time as a comparison result of the comparing unit, the relationship applying unit applies a relationship to both data obtained by the one reading process and data obtained by the another reading process, while it is so assumed that the data are related to each other.

As a consequence, each data, which is read by the input section of the external apparatus serially at the same time or continuously for one purpose, can be correlated with the reading process.

A program, according to Claim 6 of the present invention, is featured by such a program readable by a computer connected to an external apparatus in a communicable manner, which is comprised of: one, or a plurality of executing unit containing input unit; and providing unit operated in such a manner that when a process was executed by the function executing unit, under detectable condition, the providing unit provides both a time period during which the process was executed, and information for specifying the process executed in the time period; wherein: the program causes the computer to function as: detecting unit for detecting the time period; specifying unit for specifying that the process executed in the time period detected by the detecting unit corresponds to a data reading process by the input unit; storage unit for storing thereinto the time period during which the reading process specified by the specifying unit was executed and the read data in the time period in relation to each other, and for storing thereinto a condition time which is employed so as to relate the respective data read by the input unit with each other; comparing unit operated in such a manner that when another reading process different from one reading process specified by the specifying unit is specified by the specifying unit, the comparing unit compares one time instant contained in the time period corresponding to the execution of the one reading process, a specific time specified by another time point contained in the time period corresponding to the execution of the another reading process, and the condition time stored in the storage unit with each other; and relationship applying unit operated in such a manner that in the case that the specific time is shorter than the condition time, or the specific time is shorter than, or equal to the condition time as a comparison result of the comparing unit, the relationship applying unit applies a relationship to both data obtained by the one reading process and data obtained by the another reading process, while it is so assumed that the data are related to each other.

As a consequence, each data, which is read by the input section of the external apparatus serially at the same time or continuously for one purpose, can be correlated with the reading process.

### FIRST EXAMPLE

Hereinafter, a specific information management system according to an illustrative aspect of the invention will be described with reference to the drawings. The invention is not limited to the configuration described below, but may employ a variety of configurations within the same technical spirit.

(Configuration of Information Management System)

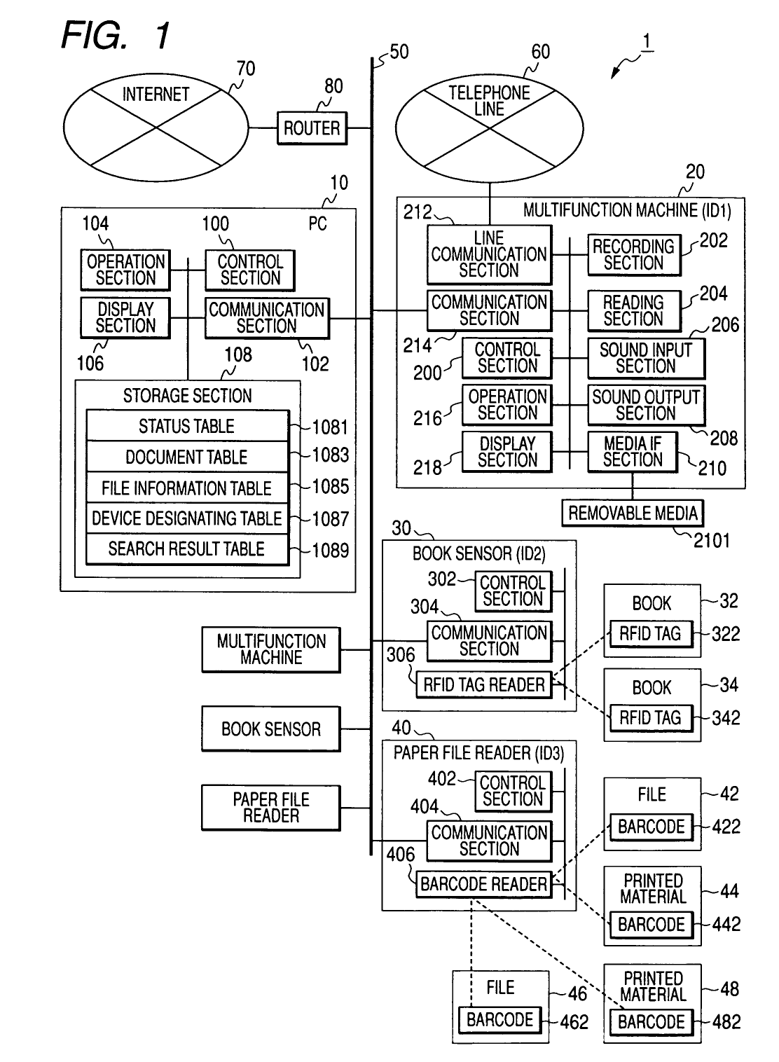

FIG. 1 is a diagram illustrating an information management system. As can be seen from the figure, the information management system 1 comprises a PC 10 as an information processing device comprising an information management function, a multifunction machine 20 as an external device for performing a variety of functions, a book sensor 30 as an external device for sensing books 32 and 34 as a management target of the PC 10, and a paper file reading section 40 as an external device for sensing paper files 42 and 46, which are stationery for filing paper as a management target of the PC 10, and printed materials 44 and 48. The devices are all connected to each other through a network line 50.

The PC 10 comprises a CPU, a ROM, and a RAM (not shown), and further comprises a control section 100 for controlling operations of the PC 10 (the entire PC 10) on the basis of programs stored in the ROM, a communication section 102 which is connected to the network line 50 so as to control the network line 50, an operation section 104 for receiving instructions from a user of the PC 10, a display section 106 for displaying a variety of information, and a storage section 108 comprising a hard disk or the like.

The storage section 108 comprises a status table 1081, a document table 1083, a file information table 1085, and a device designating table 1087. Details of the tables will be described later.

The multifunction machine 20 comprises a CPU, a ROM, and a RAM (not shown), and further comprises a control section 200 for controlling operations of the multifunction machine 20 (the entire multifunction machine 20), a recording section 202 as an image forming unit, a reading section 204 as an image reading unit, a sound input section 206 as a microphone, a sound output section 208 as a speaker, and a media IF section 210 fitted with a removable media 2101. The multifunction machine further comprises a line communication section which is connected to a telephone line 60 so as to control the telephone line 60, a communication section 214 which is connected to the network line 50 so as to control the network line 50, an operation section 216 for receiving instructions from a user of the multifunction machine 20, and a display section 218 for displaying a variety of information.

A device ID (multifunction machine ID 1) indicating that it is a device constituting the information management system 1 is given to the multifunction machine 20.

The book sensor 30 comprises a CPU, a ROM, and a RAM (not shown), and further comprises a control section 302 for controlling operations of the book sensor 30 (the entire book sensor 30), a communication section 304 which is connected to the network line 50 so as to control the network line 50, and a radio-frequency (RF) ID tag reading section 306 for reading information of RFID tags 322 and 324 given to books 32 and 34.

The book sensor 30 serves as a device for storing information indicating what book is in a user's hands at what times (is being read or is ready to be read). That is, when the RFID tag read 306 is activated on the basis of the program stored in the ROM of the control section 302 and a response is read from the RFID tag 332 or 342 of the books 32 and 34, the identification information on the RFID tag 332 or 342 and the present time (start time) are temporarily stored in the RAM of the control section 302. Then, when the response read from the RFID tags 332 or 342 ends, the identification information on the RFID tag 332 or 342 and the start time temporarily stored in the RAM of the control section 302 and the present time (end time) are transmitted to the PC 10 through the communication section 304. The PC 10 stores the information in the statue table 1081.

A device ID (book sensor ID 2) indicating that it is a device constituting the information management system 1 is given to the book sensor 30.

The paper file reading section 40 comprises a CPU, a ROM, and a RAM (not shown), and further comprises a control section 402 for controlling operations of the paper file reading section 40 (the entire paper file reading section 40), a communication section 404 connected to the network line 50 so as to control the network line 50, and a barcode reading section 406 for reading barcodes 422, 442, 462, and 482 given to the paper files 42 and 46 or the printed materials 44 and 48. The paper file reading section 40 serves as an input section for forming information, which is used to correspond the paper files 42 and 46 with the printed materials 44 and 48 filed in the paper files, in a file information table 1085. That is, the paper file reading section inputs the barcodes of the paper files through the barcode reading section 406 on the basis of a program stored in a ROM of the control section 402, and then inputs the barcodes of the printed materials, in which the barcodes are temporarily stored in a RAM of the control section 402. The input data temporarily stored are transmitted to the PC 10 through the communication section 404. The PC 10 receives the information and adds the received information to the status table 1081 and the file information table 1085.

A device ID (paper file reading section ID 3) indicating that it is a device constituting the information management system 1 is given to the paper file reading section 40.

Now, information stored in the status table 1081, the document table 1083, the file information table 1085, and the device designating table 1087, which are all stored in the storage section 108 of the PC 10, will be described.

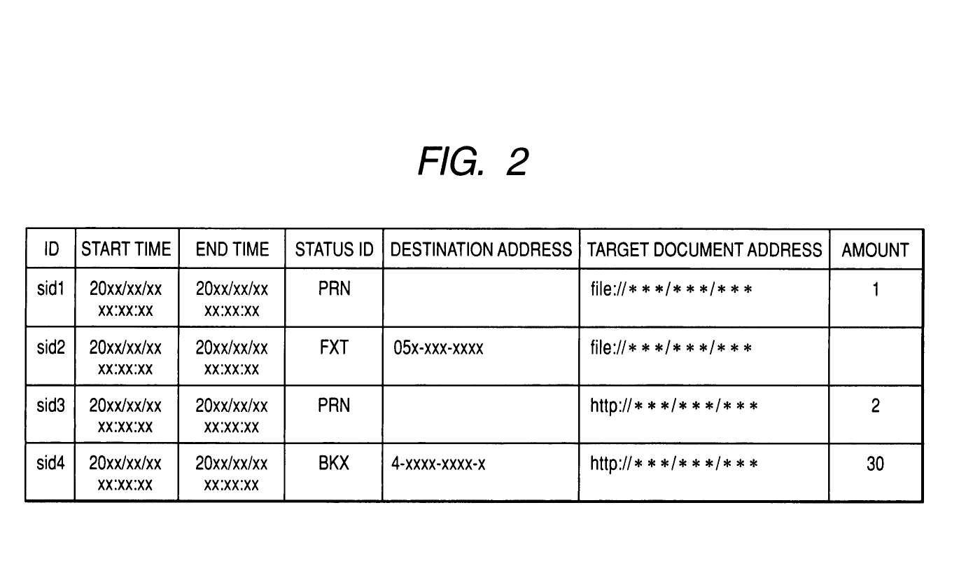

As shown in FIG. 2, the status table 1081 stores a processing operation (status ID) executed by an execution unit of the multifunction machine 20, start and end times of the processing operation (it may be properly determined when processing operation is started or ended), information indicating a location of a document which is a target of the processing operation (hereinafter, referred to as “target document”), an destination address for specifying a specific designation when the processing operation is performed to the specific designation, and an amount of the target document which is a target of the processing operation, as one record every when the processing operation is performed. A unique ID for identifying the processing operation is given to each processing operation.

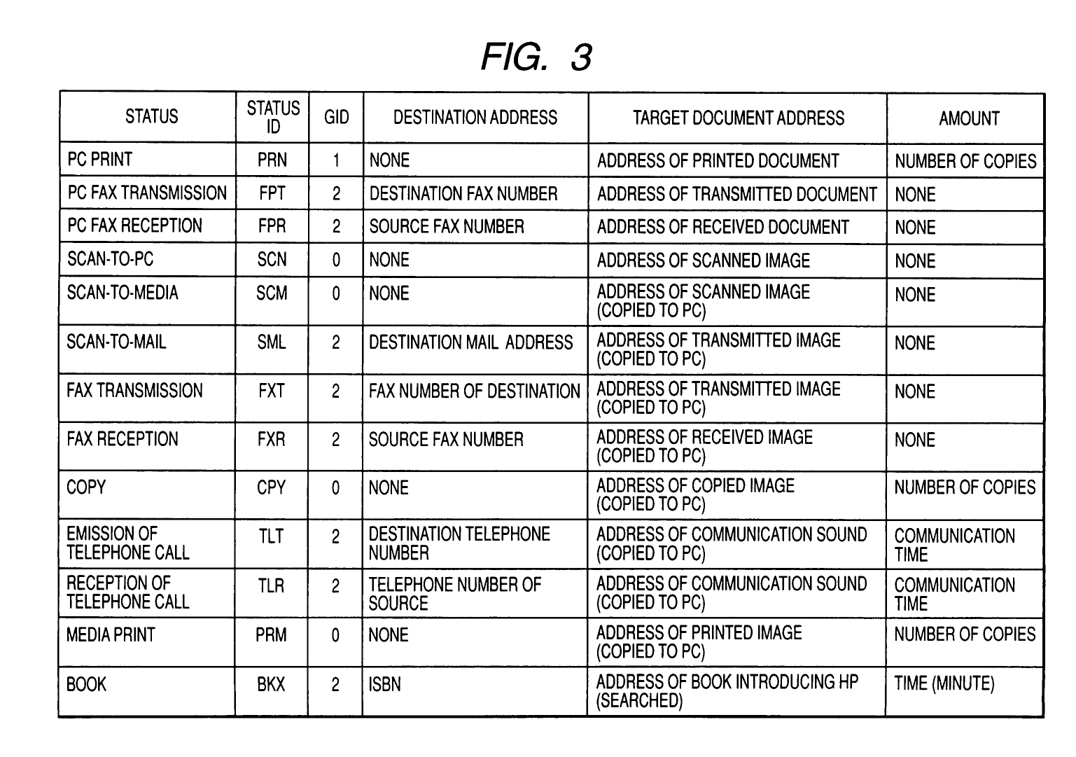

The status ID stored in the status table 1081 is defined as shown in FIG. 3. For example, when the PC 10 performs a print job using the recording section 202 of the multifunction machine 20 (this case is defined as a status “PC print” in FIG. 3), the status ID is set to “PRN”, the destination address is set to “None”, the target document address is set to “Address of printed document”, and the amount is set to “Number of copies.”

Since the PC print operation is performed between the PC 10 and the multifunction machine 20, the destination address is set to “None.” Since the document as a target of the processing operation is stored in the storage section 108 of the PC 10, an address of the storage section 108 storing the target document or an address of a homepage (hereinafter, referred to as “HP”) when the target document is a specific HP is stored as the target document address. The amount is set to the “Number of sheets.” For example, when a sheet of target document is printed, the amount is “one copy.”

When a facsimile (hereinafter, referred to as “fax”) transmission is performed using the reading section 204 and the line communication section 212 of the multifunction machine 20 (this case is defined as a status “fax transmission” in FIG. 3), the status ID is set to “FAX”, the destination address is set to “Destination FAX number”, the target document address is set to “Address of transmitted image (copied to PC)”, and the amount is set to “None.”

Since the fax transmission is performed between the multifunction machine 20 and a different facsimile machine, the destination address is set to “Destination FAX number.” In the information management system 1, when the fax transmission is performed, the transmitted image as a target of the fax transmission is stored in the storage section 108 of the PC 10. Accordingly, an address in the storage section 108 in which the transmitted image is stored (an address of the transmitted image (copied to the PC)) is defined as the “Target document address” (in the process (status) defined as “(copied to the PC)” in the target document address in FIG. 3, an address in the storage section 108 in which an image or sound is stored as a processing target as described above is defined as the target document address.).

When the books 32 and 34 managed by the PC 10 are used (this case is defined as a status “Book” in FIG. 3), the status ID is set to “BKX”, the destination address is set to “Japanese book code (hereinafter, referred to “ISBN”)”, the target document address is “Book introducing HP address (searched)”, and the amount is set to “time (minute).”

ISBN used as the destination address serves to identify the books 32 and 34 and is stored in RFID tags 322 and 342. The address of the HP introducing the books 32 and 34 is provided for a general purpose and is defined as the address stored as the target document address. The amount is set to the time (minute) for using the books 32 and 34.

In addition to those described above, “PC fax transmission (the pc transmits image data and destination to the multifunction machine 20 through the communication section 102 and the multifunction machine 20 fax transmits received image data through the line communication section 212)”, “PC fax reception (the line communication section 212 of the multifunction machine 20 transmits the received image data to the PC 10 through the communication section 214 and the PC 10 stores the received image data”, “Scan-to-PC (the multifunction machine 20 transmits the image data scanned by the reading section 204 to the PC 10 through the communication section 214 and the PC stores the received image data)”, “Scan-to-media (the image data scanned by the reading section 204 are stored in the removable media 2101 through a media interface (hereinafter, referred to as “media IF”) section 210)”, “Scan-to-mail (the image data scanned by the reading section 204 are transmitted through the communication section 214)”, “Fax reception (the image data received by the line communication section 212 are printed by the recording section 202)”, “Copy (the image data read by the reading section 204 are printed by the recording section 202)”, “Telephone transmission”, “Telephone reception”, and “Media print (the image data or the document data stored in the removable media 2101 are printed by the recording section 202) are defined respectively.

The paper file ID used as the destination address serves to identify the paper files 42 and 46 or the printed materials 44 and 48 and are given as barcodes to the paper files 42 and 46 or the printed materials 44 and 48. The address stored as the target document address is set to an address in the storage section 108 storing the document data constituting the documents or printed materials 44 and 48 filed in the paper files 42 and 46.

“GID (Group ID)” defined in FIG. 3 is an individual ID given to respective groups into which the respective processing operations (statuses) are divided. Specifically, GID “2” is given to the processing operation of which the destination address is stored, but “0” and “1” are given to the processing operations of which the destination address is set to “None.” GID “1” is given to a processing operation (only “PC print” in the illustrative aspect) using target document data previously stored in the storage section 108, and GID “0” is given to a processing operation of which target document data are stored by performing the processing operation.

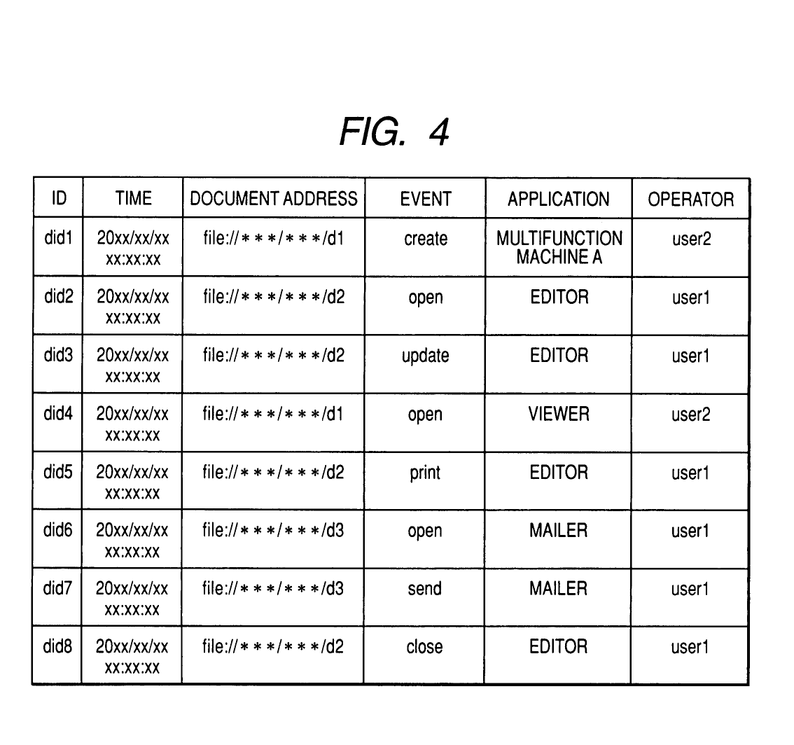

The document table 1083 stores a work or instruction performed to a document. As shown FIG. 4, ID is given to a time for performing a work (at which time instant the work is done may be properly determined), information indicating a location of the document, a work (event) performed to the document, a device performing the work (operating application), and a user carrying out the work.

Data treated in the document table 1083 comprise the document data, image data, and sound data.

Here, as a work (event) performed to a document, “create”, “open”, “update”, “print”, “send”, and “close” are defined. More specifically describing the events, when a new document is prepared, for example, when a document is prepared by a manipulation of the operation section 104 of the PC 10, when a document is scanned or copied by the use of the reading section 204 of the multifunction machine 20, the document is received in fax or in PC fax by the use of the line communication section 212, or when a communication sound is stored through telephone transmission or telephone reception using the line communication section 212, “create” is stored as an event in the document table 1083.

When the document data, the image data, or the sound data stored in the storage section 108 of the PC are opened by the use of the operation section 104 and when an HP is opened by the use of the operation section 104, “open” is stored as an event in the document table 1083. When the document data or the like are closed, “close” is stored.

When the document data, the image data, or the sound data previously stored in the storage section 108 are updated by an editor stored in the PC 10, “update” is stored as an event in the document table 1083.

When the document data or the image data previously stored is in the storage section 108 are printed by the editor, “print” is stored as an event in the document table 1083.

When the document data, the image data, or the sound data previously stored in the storage section 108 are transmitted by a mail transmitting and receiving application stored in the PC 10, or when the document data or the image data previously stored in the storage section 108 are transmitted through the PC fax transmission or the fax transmission of the multifunction machine 20, “send” is stored as an event in the document table 1083.

In the document table 1083, one of the above-mentioned items is stored as a record every when a work is performed to a document, like in the status table 1081.

Here, the status table 1081 and the document table 1083 need not be two tables different from each other, but may be one table if only the items constituting the records of the tables can be specified.

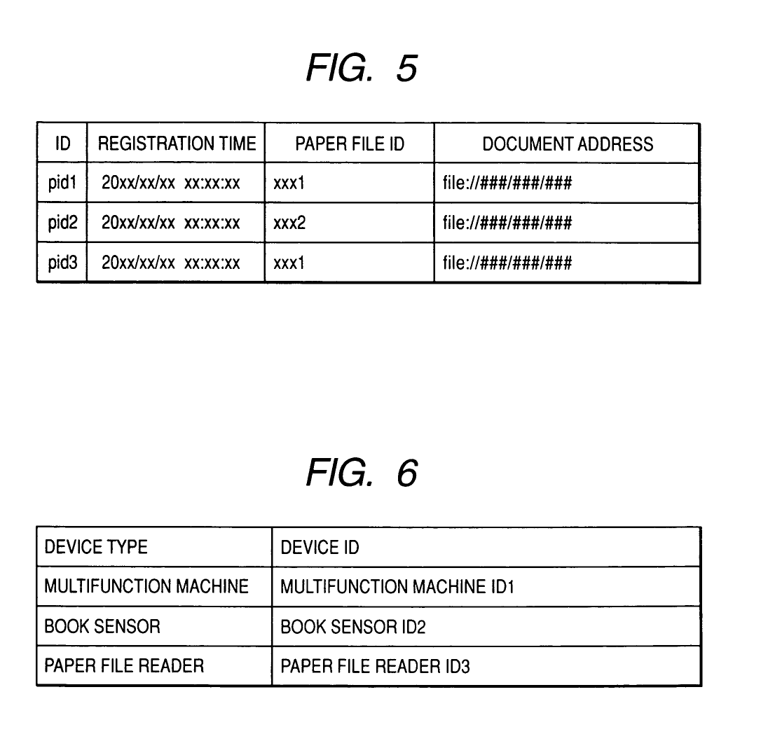

As shown in FIG. 5, a unique ID for identifying a record, a time when the record is written, a paper file ID for identifying the paper files 42 and 46, and a document address for specifying the printed materials 44 and 48 filed in the paper files 42 and 46 are stored as a record in the file information table 1085.

The paper file ID serves to identify the paper files 42 and 46 and is written in barcodes 442 and 462. The document address stored as the target document address serves to correlate the paper files 42 and 46 with the printed materials 44 and 48 filed there in and denotes an address of an electronic document resulting in the printed materials 44 and 48. That is, when the electronic document resulting in the printed materials 44 and 48 is stored in the storage section 108 of the PC 10, the address in the storage section 108 storing the electronic document is stored as the document address, or when the electronic document is an HP, the address of the HP is stored as the document address. The information is written to the barcodes 442 and 448 recorded in the printed materials 44 and 46.

When a plurality of multifunction machines 20, the book sensor 30, and the paper file reading section are connected to the network line 50, the device designating table 1087 is a table which specifies and stores a target of the information management system 1 among the multifunction machines 20 and the like. The device designating table comprises the structure shown in FIG. 6.

(Process 1 of Information Management System)

Next, process (1) of the information management system illustrated as above will be described with reference to the figures.

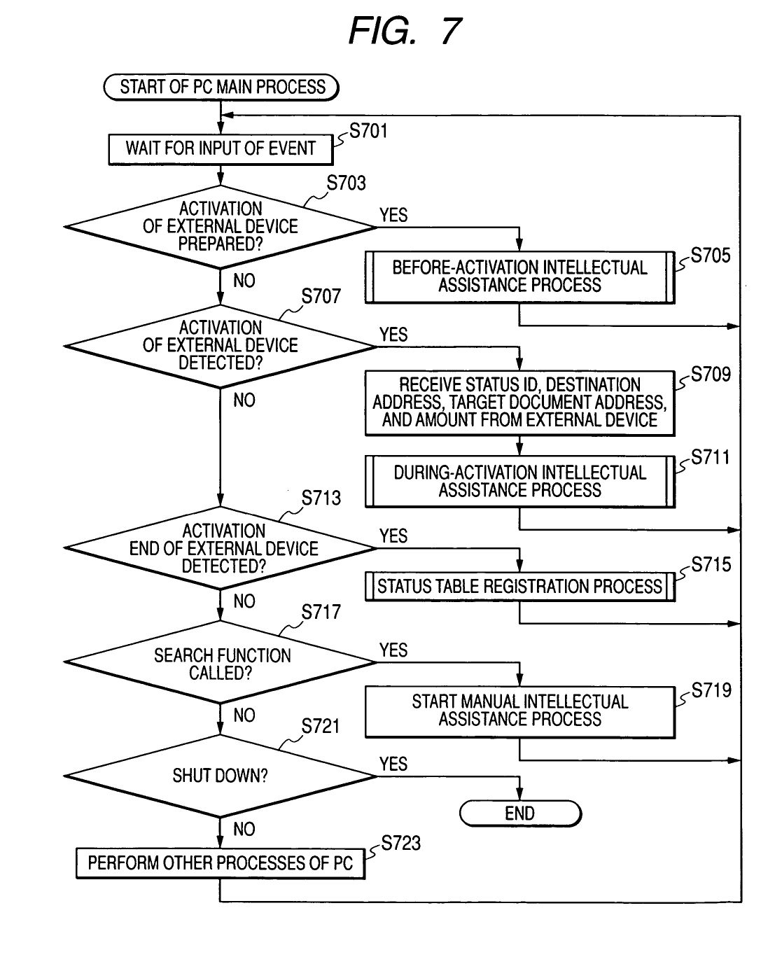

FIG. 7 is a diagram illustrating a flow of a main process performed by the PC 10. The process shown in the flow is performed by the control section 100 of the PC 10, and more specifically, the CPU of the control section 10 performs the process by the use of a program stored in the ROM or the like.

First, the control section 100 waits until an instruction for performing any one process is input through the operation section 104 of the PC 10 or the communication section 102 from a designated external device shown in FIG. 6, such as the multifunction machine 20, the book sensor 30, and the paper file reading section 40 (step 701).

Thereafter, when it is detected in step 701 that an instruction is given, the process is specified. That is, when an instruction is input to the control section 100 first determines whether the instruction is an instruction for activating a printer driver controlling the recording section 202 of the multifunction machine 20 or an instruction for preparing for activation of the external device such as activation of a multifunction machine utility for using the reading section 204 of the multifunction machine 20 (step 703).

When it is determined in step 703 that the input instruction is to prepare for the activation of the external device (step 703: YES), the control section 100 of the PC 10 performs a before-activation intellectual assistance process to be described later and waits until an instruction for performing a process is input (step 701).

The before-activation intellectual assistance process unit a process of alarming a user having given the instruction so as to prevent the redundant printing when an instruction for printing the specified document data is given to the recording section 202 of the multifunction machine 20 from the PC 10 but the process of printing the document is previously performed within a predetermined time. The before-activation intellectual assistance process comprises a process of alarming a user having given a fax transmission instruction so as to prevent the redundant fax transmission when the fax transmission instruction for transmitting specific document data to a specific counter party is given to the line communication section 212 of the multifunction machine 20 from the PC 10 but the document data are previously transmitted to the counter party.

On the other hand, when the input instruction is not to prepare for the activation of the external device (step 703: NO), it is determined whether the instruction detected in step 701 is an instruction from one of the multifunction machine 20, the book sensor 30, and the paper file reading section 40 designated in FIG. 6 and an instruction for detecting the activation of the external device (step 707).

When it is determined in step 707 that the instruction is an instruction for detecting the activation of the external device (step 707: YES) , the control section 100 receives the information defined in FIG. 3, that is, the status ID, the destination address, the target document address, and the amount, from the external device (step 709). The status ID and the like are stored in the RAM of the control section 100.

Then, the control section performs a during-activation intellectual assistance process (step 711) and then waits until an instruction for performing another process is input when the process is finished (step 701).

The during-activation intellectual assistance process unit a process for providing the information used until that time as information associated with a present work when a process corresponding to the same instruction as the instruction from the external device was performed in the past.

When the input instruction is not to prepare for the activation of the external device (step 707: NO), it is determined whether the instruction detected in step 701 is to detect the end of the detected activation of the external device (step 713).

When it is determined in step 707 that the instruction is to detect the end of the activation of the external device (step 713: YES), the control section 100 performs a status-table registration process to be described later (step 715) and then waits until an instruction for performing another process is input when the status-table registration process is finished (step 701).

When the input instruction is not to end the activation of the external device (step 713: NO), it is determined whether the instruction detected in step 701 is to call a search function (step 717).

When it is determined in step 717 that the input instruction is to call a search function (step 717: YES), the control section performs a manual intellectual assistance process to be described later (step 719) and then waits until an instruction for performing another process is input when the manual intellectual assistance process is finished (step S701).

The manual intellectual assistance process is to provide a user with information associated with a user' present work in response to a condition designated by the user.

When the input instruction is not the manual intellectual assistance process (step 717: NO), it is determined whether the instruction detected in step 701 is to shut down the PC 10 (step 721). When the instruction is to shut down the PC 10 (step 721: YES), the PC 10 is shut off. When the instruction is not to shut down the PC (step 721: NO), a process corresponding to the instruction is performed (step 723). After performing the process, the control section waits until an instruction for performing another process is input (step 701).

(Before-Activation Intellectual Assistance Process)

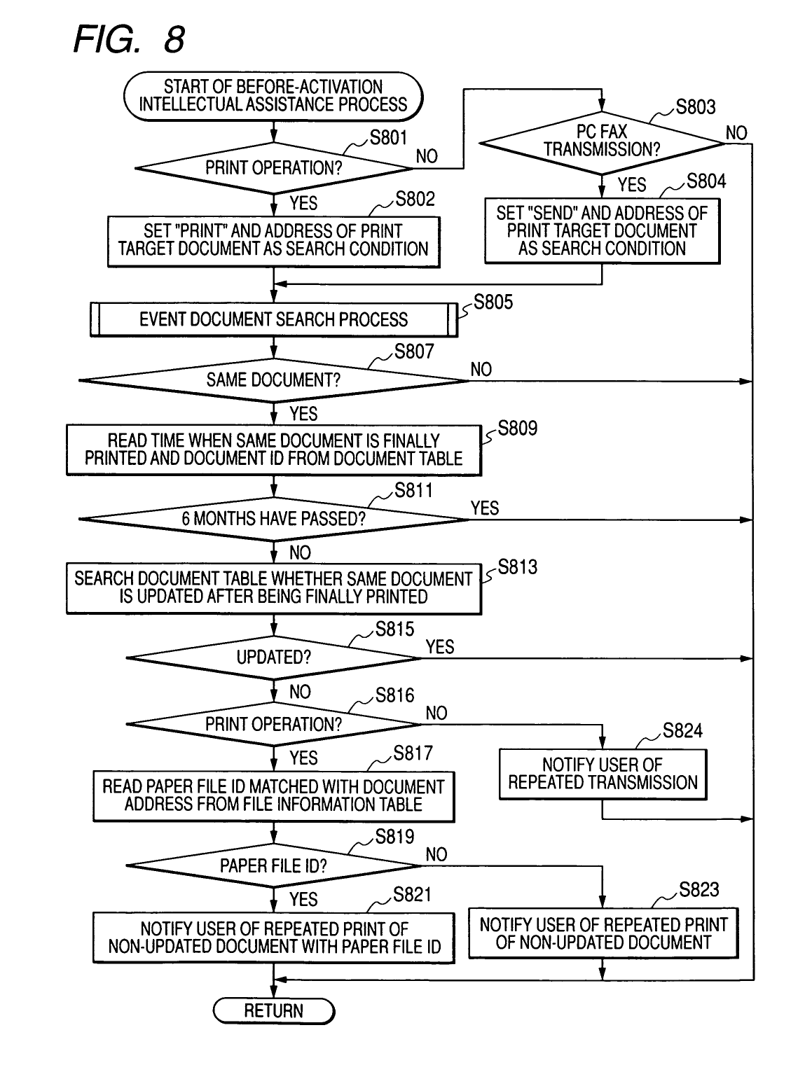

FIG. 8 is a diagram illustrating a flow of a before-activation intellectual assistance process.

When the before-activation intellectual assistance process is performed instep 705, it is first determined whether the input instruction for preparing for the activation of the external device is a printing instruction to the recording section 202 (step 801). When the input instruction is the printing instruction (step 801: YES), step 802 is performed. On the other hand, when the input instruction is not the printing instruction (step 801: NO), it is determined whether the input instruction for preparing for the activation of the external device is a PC fax transmission instruction to the line transmission section 212 (step 803). When the input illustration is the fax transmission instruction (step 803: YES), the process proceeds to step 804. When the input instruction is not the PC fax transmission instruction (step 803: NO), the control section ends the before-activation intellectual assistance process and waits again in step 701 until an instruction for performing another process is input.

Instep 802, in order to confirm whether the same document data as the document data to be printed exist in the previously printed documents, that is, in the documents of which the event is stored as “print” in the document table shown in FIG. 4, the event “print” and the address of the document data to be printed are set as search conditions and an event document search process is performed on the basis of the two search conditions (step 805).

Instep 804, in order to confirm whether the same document data as the document data to be transmitted in a PC fax manner and a record of transmission to the same designation exist in the previously transmitted documents, that is, in the documents of which the event is stored as “send” in the document table shown in FIG. 4, the event “send”, the destination address (fax number) of the PC fax transmission, and the address of the document data to be transmitted are set as search conditions and the event document search process is performed on the basis of the two search conditions (step 805).

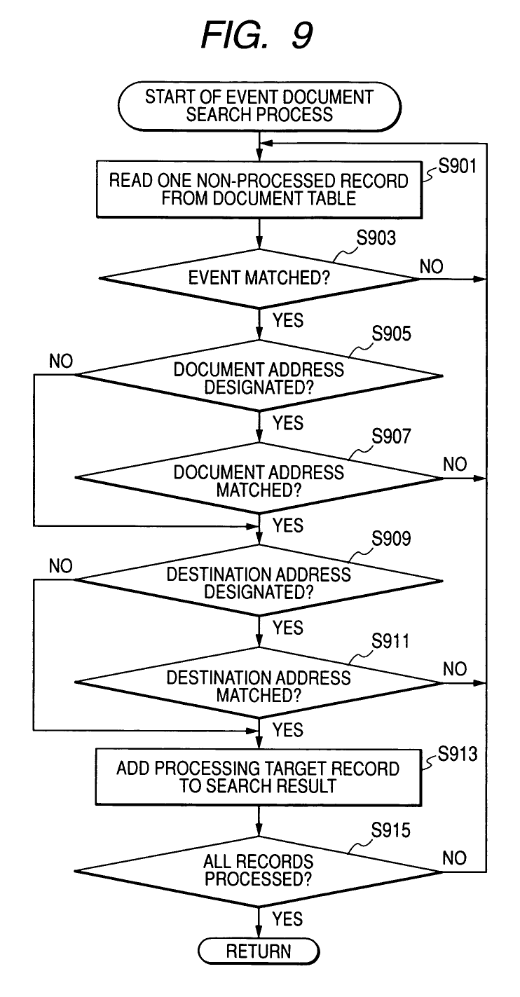

FIG. 9 is a diagram illustrating a flow of the event document search process. When the process starts, the control section 100 first reads one record, to which the process is not performed yet, from a document database 1083 (step 901). Then, the control section determines whether an event of the record to be processed is matched with the event “print” (“send”) set as the search condition in step 802 (or step 804) (step 903). Here, when the event of the record to be processed is not “print” (“send”) (step 903: NO), the record is excluded from the processing target and the process of step 901 is performed again.

On the other hand, when the event of the record to be processed is “print” (“send”) (step 903: YES), the control section determines whether the document address is set as the search condition of step 802 (or step 804) (step 905).

When it is determined instep 905 that the document address is set as the search condition of step 802 (or step 804) (step 905: YES), it is determined whether the document address of the record to be processed is matched with the document address designated as the search condition (step 907). When it is determined that the document addresses are matched with each other (step 907: YES), the process of step 909 is performed. When it is determined that the document addresses are not matched with each other (step 907: NO), the process of step 901 is performed again.

When it is determined in step 905 that the document address is not set as the search condition (step 905: NO), the process of step 907 is not performed, but the process of step 909 is performed.

When it is determined in step 909 that the destination address is set as the search condition of step 802 (or step 804) (that is, step 909: YES, when step 804 is performed), it is determined whether the destination address of the record to be processed is matched with the destination address designated as the search condition (step 911). When it is determined that the destination addresses are matched with each other (step 911: YES), the process of step 913 is performed. When it is determined that the destination addresses are not matched with each other (step 911: NO), the process of step 901 is performed.

When it is determined in step 909 that the destination address is not set as the search condition (that is, step 909: NO, when step 802 is performed), the process of step 911 is not performed, but the process of step 913 is performed.

When it is not determined in step 911 whether the destination addresses are matched with each other (step 905: NO or step 907: YES and step 909: NO), or when it is determined in step 911 that the destination addresses are matched with each other (step 905: NO or step 907: YES, step 909: YES, and step 911: YES), it is considered that the document data set as the search condition are previously printed or the document data set as the search condition are previously transmitted to the same designation, and thus the record to be processed is added to the search result (step 913).

Thereafter, it is determined in step 915 whether the event document search process has been performed to all the records of the document table. When the process has not been performed to all the records (step 915: NO), the process of step 901 is performed again. When the process has been performed to all the records (step 915: YES), the event document search process is finished and the process of step 807 is performed.

In step 807, it is determined whether the same document exists through the event document search process of step 805. Here, when it is determined that the same document does not exist (step 807: NO), the document data to be processed are not printed or transmitted to the same designation. Accordingly, the control section does not perform the subsequent processes (that is, performs the print or transmission process), but waits until the next input is performed.

On the contrary, when the same document exists (step 807: YES), the ID and time associated with the latest record (finally printed or transmitted) are read from the records, which determined to be identical (step 809) and it is then determined whether the time passes 6 months from the present time (step 811).

When it is determined that the time passes 6 months (step 811: YES), the document data to be processed are redundantly printed or transmitted to the same designation. However, since a considerable time has passed from the final print or transmission, the control section does not perform the subsequent processes (that is, performs the print or transmission process), but waits again in step 701 until the next input is performed.

On the contrary, when it is determined that the time does not pass 6 months (step 811: NO), it is determined from the document table (see FIG. 4) whether the same document is updated (event “update”) after finally printed (event “print”) or transmitted (event “send”) (step 813).

When it is determined in step 815 that the same document is updated (step 815: YES), the control section performs the print or transmission process and then waits in step 701 until the next input is performed. On the other hand, when it is determined that the same document is not updated (step 815: NO), the type of manipulation is determined. When the manipulation indicates a print process (step 816: YES), the paper file ID corresponding to the document address is read from the file information table 1085 (step 817) so as to determine whether the previously printed document is managed in the file information table 1085 (see FIG. 5) along with the paper file ID thereof.

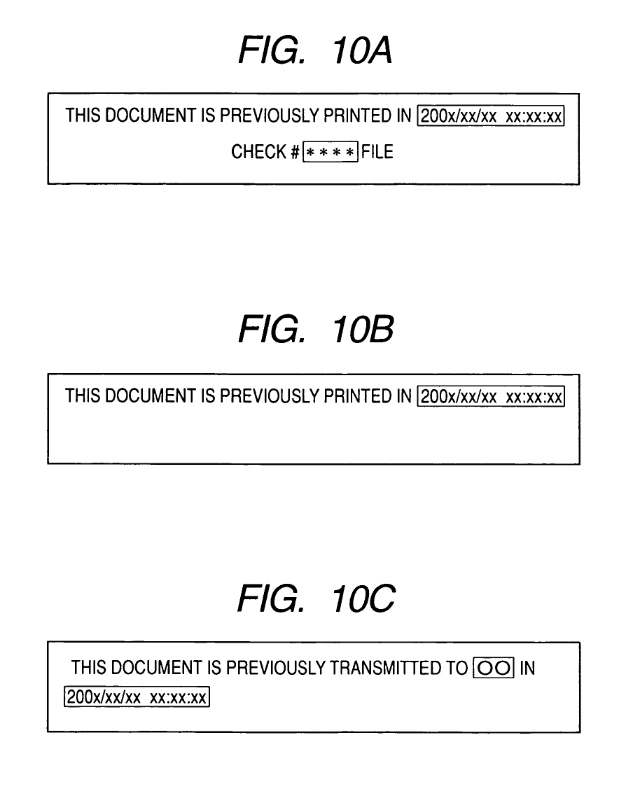

When it is determined in step 817 that the corresponding paper file ID exists in the file information table 1085, it is notified to the user in the manner shown in FIG. 10A that this print job is to redundantly print the non-updated document with the paper file ID (step 821).

On the other hand, when the corresponding paper file ID does not exist in the file information table 1085, it is notified to the user in the manner shown in FIG. 10B that the non-updated document is redundantly printed (step 823).

When the manipulation indicates a PC fax transmission (step 816: NO), it is notified to the user in the manner shown in FIG. 10C that the same document is transmitted to the same designation (step 824).

(During-Activation Intellectual Assistance Process)

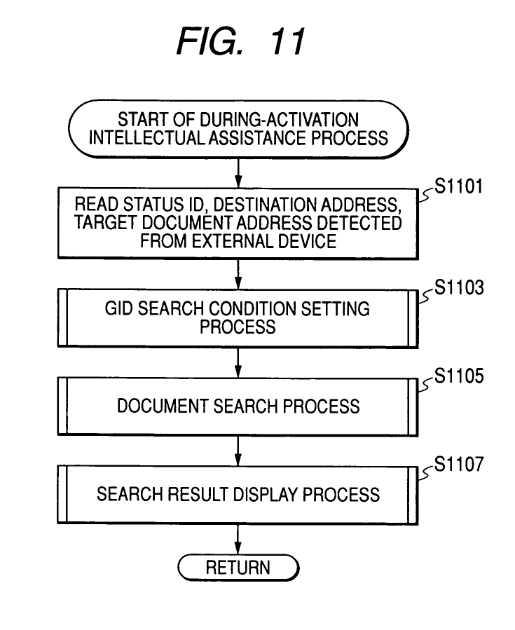

FIG. 11 is a diagram illustrating a flow of a during-activation intellectual assistance process.

In step 711, when the during-activation intellectual assistance process is performed, the control section 100 of the PC 10 first reads the status ID, the destination address, and the target document address input (detected) from the external device instep 709 (step 1101) and performs a GID search condition setting process (step 1103).

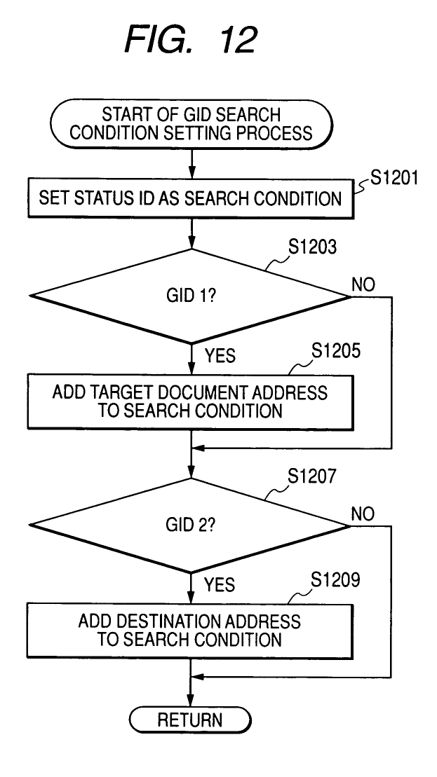

FIG. 12 is a diagram illustrating a flow of a GID search condition setting process. First, the status ID (see FIGS. 2 and 3) is set as the search condition (step 1201). Next, in order to specify a search condition for performing the search in a so-called “AND condition” with the status ID set in step 1201 when the document search process of step 1105 is performed, the format of a GID is determined to extract a search condition specific to the respective processing operations. That is, it is first determined whether the GID of the status ID set in step 1201 is “1” (see FIG. 3) (step 1203).

When it is determined in step 1203 that the GID is “1” (step 1203: YES), the target document address is added as the search condition (step 1205) and the process of step 1207 is performed. When it is determined in step 1203 that the GID is not “1”, the process of step 1205 is not performed, but the process of step 1207 is performed.

In step 1207, it is determined whether the GID of the status ID set in step 1201 is “2” (see FIG. 3) (step 1207).

When it is determined in step 1207 that the GID is “2” (step 1207: YES), the destination address is added as the search condition (step 1209). The GID search condition setting process is finished and then the document search process (step 1105) is performed using the search conditions specified through the GID search condition setting process.

On the other hand, when it is determined in step 1207 that the GID is not “2”, the GID search condition setting process is finished. Then, the document search process (step 1105) is performed using the search conditions specified through the GID search condition setting process.

When “NO” is determined together in steps 1203 and 1207, it is the case in which the GID corresponding to the status ID is “0.”

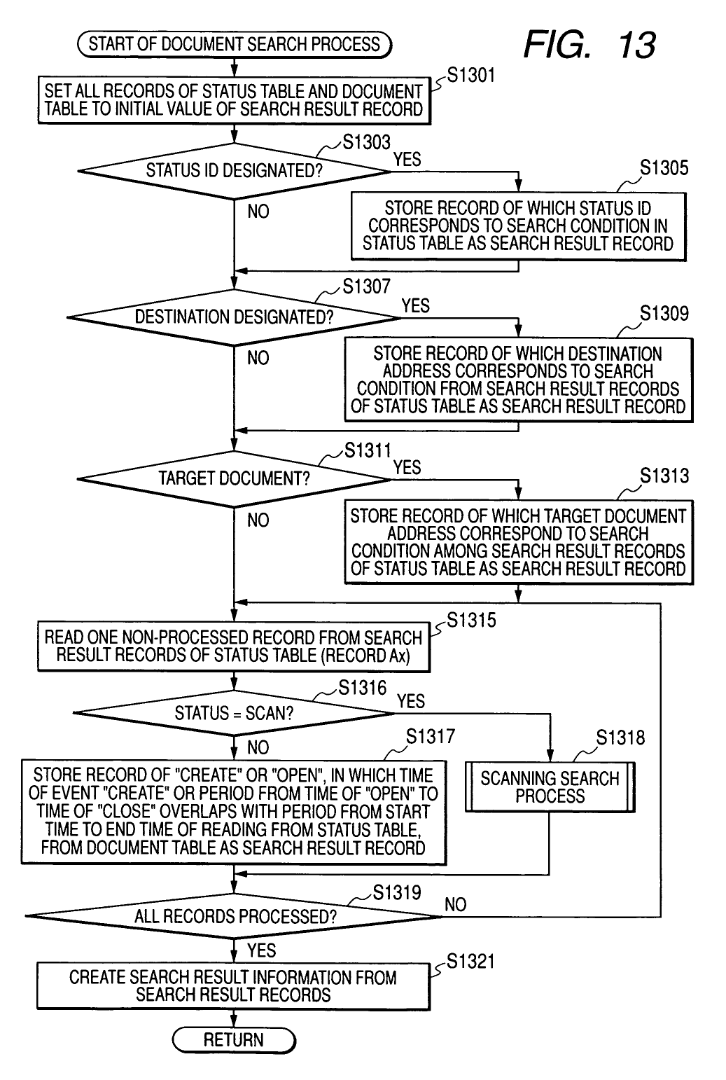

FIG. 13 is a diagram illustrating a flow of the document search process (step 1105). First, all the records of the status table 1081 and the document table 1083 are set to the initial value of a search result record (step 1301).

Next, in order to specify a target document associated with a specific record from the status table 1081, a search process is performed with the search conditions set in the GID search condition setting process (step 1103) previously performed.

That is, first, it is determined in step 1303 whether the status ID is designated as the search condition (step 1303). In the during-activation intellectual assistance process (step 711), the status ID is generally set as the search condition in step 1201. Accordingly, the determination of step 1303 is “YES”, a record corresponding to the status ID set as the search condition from the status table 1081 is stored as a new search result record (step 1305), and then the process of step 1307 is performed.

In step 1307, it is determined whether the destination address is set as the search condition, that is, whether the determination of step 1207 is “YES” and the destination address is added as the search condition in step 1209. When it is determined that the destination address is set (step 1307: YES), a record corresponding to the destination address designated as the search condition from the search result records stored in step 1305 is stored as a new search result record (step 1309), and then the process of step 1311 is performed. When it is determined in step 1307 that the destination address is not set as the search condition (step 1307: NO), the process of step 1309 is not performed, but the process of step 1311 is performed.

It is determined in step 1311 whether the target document address is set as the search condition, that is, whether the determination of step 1203 is “YES” and the target document address is set as the search condition in step 1205. When it is determined that the target document address is set (step 1311: YES), a record corresponding to the target document address designated as the search condition from the search result records stored in step 1305 is stored as a new search result record (step 1313), and then the process of step 1315 is performed. When it is determined in step 1311 that the target document address is not set as the search condition (step 1311: NO), the process of step 1313 is not performed, but the process of step 1315 is performed.

In steps 1309 and 1313, a new search result record corresponding to the respective search conditions is stored on the basis of the search result record specified in step 1305. This is because only one GID corresponding to the respective status ID is set (see FIG. 3).

In step 1315, in order to perform processes subsequent to either step 1317 or step 1318, the control section 100 reads out one search result record of non-processed operations from the search result records which are specified from the above-described step 1303 to step 1313 (actually reads out 1 record of status table 1081), and then, executes a process defined in step 1316.

In step 1316, the control section 100 determines as to whether or not the status ID of the search result record read in step 1315 corresponds to processing operation (event) related to image reading and saving operation by using the reading section 204, i.e. any one of a scan-to-PC (status ID is defined as “SCN”) and a scan-to-media (status ID is defined as “SCM”). Then, as a result of this judgment, when the control section 100 determines that the status ID recited in the search result record read out in step 1315 does not correspond to any one of “SCN” and “SCM” (“NO” in step 1316), the control section 100 subsequently executes a process defined in step 1317.

On the other hand, when the control section 100 determines that the status ID recited in the search result record read out instep 1315 corresponds to any one of “SCN” and “SCM” (“YES” in step 1316), the control section 100 subsequently executes a process defined in step 1318.

In step 1317, in the records stored in the document table 1083 and set to the initial value of the search result record in step 1301, when a period from the time registered in the record comprising the event “create” or “open” to the time registered in the record comprising the event “close” and the same document address as the document address of the record comprising the event “create” (that is, a period when it can be determined that the same document is “opened” or “treated” by the PC 10) overlaps with the period from the start time to the end time of the record read from the status table 1081 in step 1315, the record to be processed in the document table 1083 is stored as the search result record in the search result table 1089 (step 1317).

That is, in the process (step 1321), the document which, it is determined, opened or treated at the same time as the external device suitable for the instructed search condition is extracted.

In the information management system 1 according to the first illustrative aspect, the document data comprising the above-mentioned correlation are considered as having a high correlation with each other. Therefore, as described above, the records comprising the event “create” or “open” of which the processing times overlap with each other are stored as the search result records.

When the period from the time registered in the record comprising the event “create” or “open” to the time registered in the record comprising the event “close” and comprising the same document address as the document address of the record comprising the event “create” is determined, the identity of the user (operator in FIG. 4) is considered.

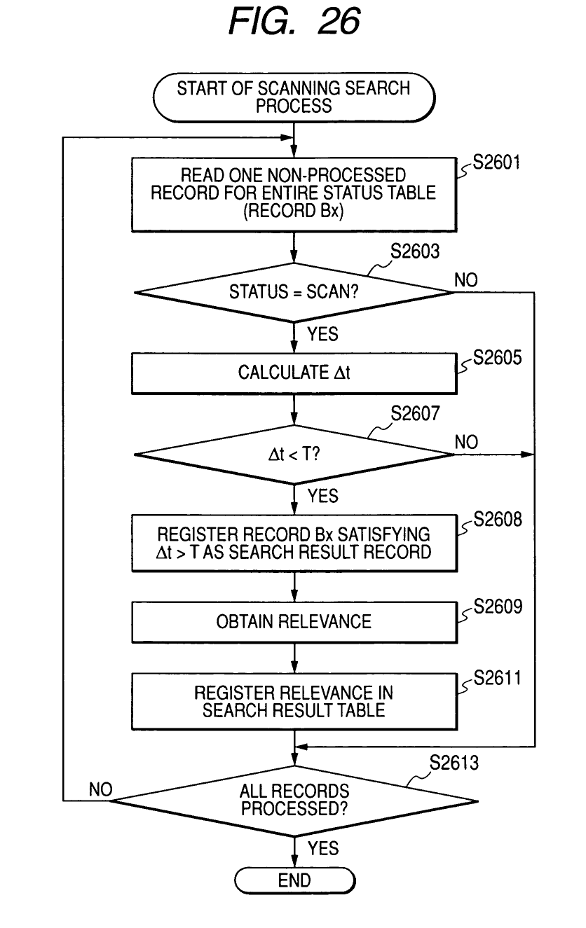

FIG. 26 is a flow chart for explaining flow operations as to scanning search process.

The control section 100 reads out a target record (non-processed record) to be processed by this scanning search process (step 1318) from the entire records of the status table 1081 with respect to the search result record read in step 1315. A process of step 2603 is subsequently executed. In the following explanation for the scanning search process, the search result record read in step 1315 is referred to as a “record Ax”, and a non-processed record is referred to as a “record Bx”.

In step 2603, the control section 100 determines as to whether or not a status ID described in the record Bx corresponds to any one of “SCN” and “SCM”. In a case where this condition is satisfied (“YES” in step 2603), the control section 100 executes a process of step 2605. On the other hand, in a case where the control section 100 determines that the status ID described in the record Bx does not correspond to any one of “SCN” and “SCM”, the control section 100 executes a process of step 2613.

In step 2605, taking account of a relation between the record Ax and the record BX, a specific time (Δt), which is specified by executing the reading (scanning) process of the data related to the record Ax and the reading (scanning) process of the data related to the record Bx, is calculated.

Specifically, when the reading process of the document data related to the record Ax is executed before the reading process of the document data related to the record Bx, the control section 100 subtracts a start time recited in the record Bx from an end time recited in the record Ax and calculate the specific time (Δt). Also, when the reading process of the document data related to the record Ax is executed after the reading process of the document data related to the record Bx, the control section 100 subtracts a start time recited in the record Ax from an end time recited in the record Bx and calculate the specific time (Δt).

After step 2605, the control section 100 compares the specific time (Δt) specified in this step 2605 with a condition time (T) stored in the storage section 108 (step 2607).

In this case, in case where a user inputs data (execution of reading process) at the same time serially or by continuously employing the same unit, the inputted data are conceived to be repeatedly inputted for one purpose. In other words, the condition time (T) is employed as a reference in order to determine as to whether or not the document data specified based upon the document addresses recited in both the records are read during the same process. Reading operations separated by a time interval exceeding the condition time (T) are determined to be based upon different works.

In a case where the specific time (Δt) is shorter than (“shorter than or equal to” maybe set as condition) the condition time (T) (“YES” in step 2607), the record Bx is stored as a search result record assuming that the document data specified based upon the document address recited in the record Bx is read in the same process as the reading process related to the record Ax (step 2608).

On the other hand, in a case where the specific time (Δt) is longer than or equal to (“longer than” may be set as condition) the condition time (T) (“NO” in step 2607), the process proceeds to step 2613 assuming that the document data specified based upon the document address recited in the record Bx is read in the different work from the reading process related to the record Ax.

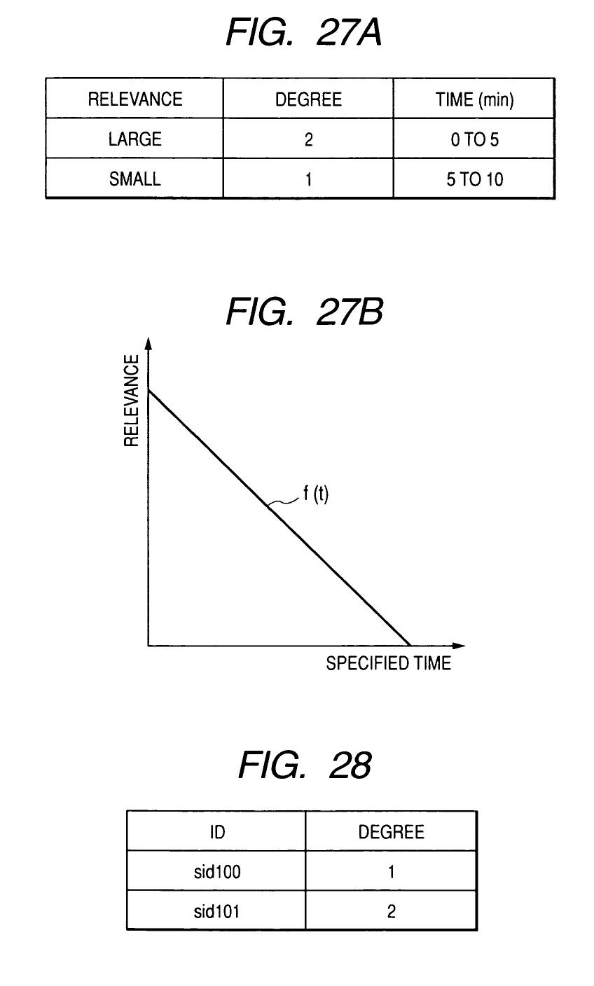

In step 2609, a degree of relevance between the records which are judged to be relevant to each other. Specifically, as shown in FIG. 27A, a degree (weight) of relevance is previously determined based upon a time interval of a specific time. A degree of relevance between both the records is determined based upon a relation between the time interval and the degree and the specific time (Δt) calculated in step 2605, and stored in the search result table 1089 (refer to FIG. 28) (step 2611).

The degree of the relevance is not only applied by FIG. 27A. The degree of the relevance may be calculated by a decreasing function “f(t)” as shown in FIG. 27B is defined and the specific time (Δt) is substituted for this decreasing function “f(t).” In this case, the process of step 2607 is not executed. The degree of the relevance calculated based upon the decreasing function “f(t)” with the predetermined degree of the relevance. A similar determining process to step 1607 based upon this comparison result may be performed (in this process, step 2607 is not required, above comparing and judging operations are carried out after step 2609).

In step 2613, it is determined as to whether or not the above process for the entire records Bx of the status table 1081 is accomplished. When the condition is satisfied (“YES” in step 2613), the process ends, and a process of step 1319 is executed. On the other hand, when the condition is not satisfied (“NO” in step 2613), the process is returned to step 2601 in which the above steps are repeated.

In the above scanning search processes, the process of the step 1316 is limited to the scan-to-PC and the scan-to-media. However, the application range is not limited thereto, but may be employed based upon a content of the process. For example, a telephone calling operation (defined by status ID “TLT”) and a telephone call receiving operation (defined by status ID “TLR”) in which data (voice) is entered via the line communication section 212, maybe employed. Further, a scan-to-mail (defined as status ID “SML”) and a FAX transmission (defined as status ID “FXT”) in which only transmission route of input data is different may be employed.

As to a process having no related process, or a plurality of processes where it is determined that these plural processes are not combined with each other but these processes are properly related to each other, the judgment of step 1316 may be made with respect to a single process.

In step 1319, it is determined whether the process of step 1317 is performed to all the records stored as the search result records in the status table 1081. When it is determined that the process is performed to all the records (step 1319: YES), search result information is prepared from the search result table 1089 and the search result record of the status table 1081 based on the above-mentioned process (step 1321), and then the document search process (step 1105) ends. When it is determined that the process is not performed to all the records (step 1319: NO), the processes repeat from step 1315.

In the information management system 1 according to the illustrative aspect, since the records stored in the status table 1081 are stored as records in the document table at the time of performing the processing operation (see “Document Table Updating Process” to be described later), the records in both tables satisfy the search conditions instep 1317 and are stored as the search result records.

Accordingly, since the search result records stored based on the records stored through the same process is excluded, the start time or the end time of the search result record specified from the status table 1081 is preferably equal to the time of the document table 1083. In addition, even when the condition of step 1317 is satisfied, the search result records in which the target document address and the document address are identical are preferably not stored in step 1317.

When the document search process (step 1105) is finished, the control section 100 performs a process of displaying the search result based on the document search process (step 1105) (step 1107).

At a step 1317 in the document search process, the determination using the overlapping of two periods has been performed. However, when the time registered in the record comprising the event “create”, “open”, or “close” is comprised in the period from the start time to the end time of the records in the status table 1081, both periods necessarily overlap with each other. Accordingly, except for the case in which the period from the start time to the end time of the record in the status table 1081 is all comprised in the period from the time registered in the record comprising the event “create” or “open” to the time registered in the record comprising the event “close” and comprising the same document address as the document address of the record comprising the event “create” or the like, it is preferable in view of rapid determination to employ this simple determination along with the determination of step 1317.

Similarly, when one of the start time and the end time of the record of the status table 1081 is comprised in the period from the start time of the record comprising the event “create” or “open” to the time registered in the record comprising the event “close” and comprising the same document address as the document address of the record comprising the event “create” or the like, both periods necessarily overlap with each other. Accordingly, as described above, it is preferable in view of rapid determination to employ this simple determination along with the determination of step 1317.

When the time registered in the record comprising the event “create”, “open”, or “close” overlaps with one of the start time or the end time of the record in the status table 1081, both periods necessarily overlap with each other. Accordingly, as described above, it is preferable in view of rapid determination to employ this simple determination along with the determination of step 1317.

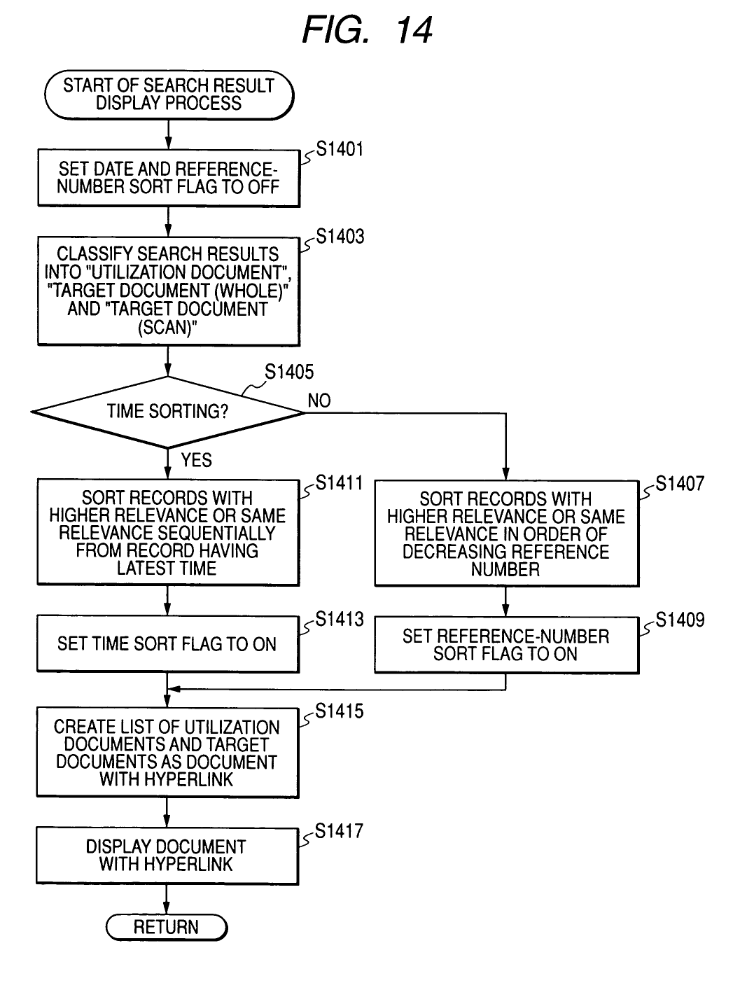

FIG. 14 is a diagram illustrating a flow of a search result display process (step 1107). First, at the time of starting the process, the date and the reference sort flag are set to OFF (step 1401).

Next, the search result records specified as the search result information prepared in step 1321 are classified into search result records specified from the status table 1081 (specified through steps 1303 to 1313), search result records specified from a record in the status table 1081 where the status ID is “SCN” or “SCM” (step 1318) and search result records (the search result table 1089) specified from the document table 1083 (specified through steps 1315 to 1319). The former two are a search result associated with a target document (whole) and a target document (scan) and the latter is a search result associated with a utilization document. The search result records are classified into both search results (step 1403).

When the process of step 1403 is finished and then the search result information for classification into the utilization documents and the target documents (whole) and target documents (scan) in step 1403 is displayed, a process of determining in what order the utilization documents, the target documents (whole) and the target documents (scan) are displayed is performed.

First, it is determined in step 1405 whether a time sorting method is selected for the display order (step 1405).

When the reference number sorting is employed, i.e. the time sorting method is not selected (step 1405: NO), the search results comprising the same weight in the order of estimation values (weights) set in the document search process for scan of step 1318 or comprising no weight (utilization documents and target documents (whole)) are sequentially sorted from the search result record comprising the largest weight and reference number on the basis of both search results classified into the utilization documents, target documents (whole) and the target documents (scan) instep 1403 (step 1407), and then the reference number sort flag is set to ON (step 1409). Thereafter, the process of step 1415 is performed.

On the other hand, when the time sorting method is selected (step 1405: YES), the control section 100 sequentially sorts the search results comprising the same weight in the order of weights set in step 1318 or having no weight (target documents) from the search result for scan record comprising the latest time on the basis of both search results classified into the utilization documents and the target documents in step 1403 (step 1411), and then the time sort flag is set to ON (step 1413). Thereafter, the process of step 1415 is performed as described above.

In the information management system 1 according to the first illustrative aspect, the search result records can be sorted in the order of weights of the records and the search results comprising the same weight can be sorted using two items of time and reference number at the time of displaying the search results. Accordingly, it can be determined as follows in which of the time and the reference number the search results are sorted. That is, by determining whether the search results are sorted in one item, specifically, by determining whether the time sorting method is selected, it can be determined by the use of which of the time and the reference number a user intends to sort the search results (when the search results comprise the same weight and the time sorting method is not selected, it is considered that the reference number sorting method is selected).

When the search results are sorted in the order of weights, the time or the reference number, which is used to sort the search results maybe selected by the user through the operation section 104, for example, after performing the process of step 1401 and before performing the process of step 1405.

Instep 1415, lists of the utilization documents, target documents (whole) and the target documents (scan) are prepared so as to access the documents on the basis of the search result records sorted in accordance with the condition selected in step 1407 or 1411. The lists are displayed in step 1417.

In the information management system 1 according to the first illustrative aspect, when the activation of the external device is detected in step 707, the during-activation intellectual assistance process (step 711) is performed in response to the detection. Accordingly, since the documents which are considered as being opened or treated at the same time in the past can be notified to the user with the detecting operation. As a result, when a process is necessary for the documents associated with this process, the necessary process can be performed at the same time.

For example, in case of fax transmission, it is possible to determine whether the documents opened at the time of the previous fax transmission should be transmitted by opening the documents.

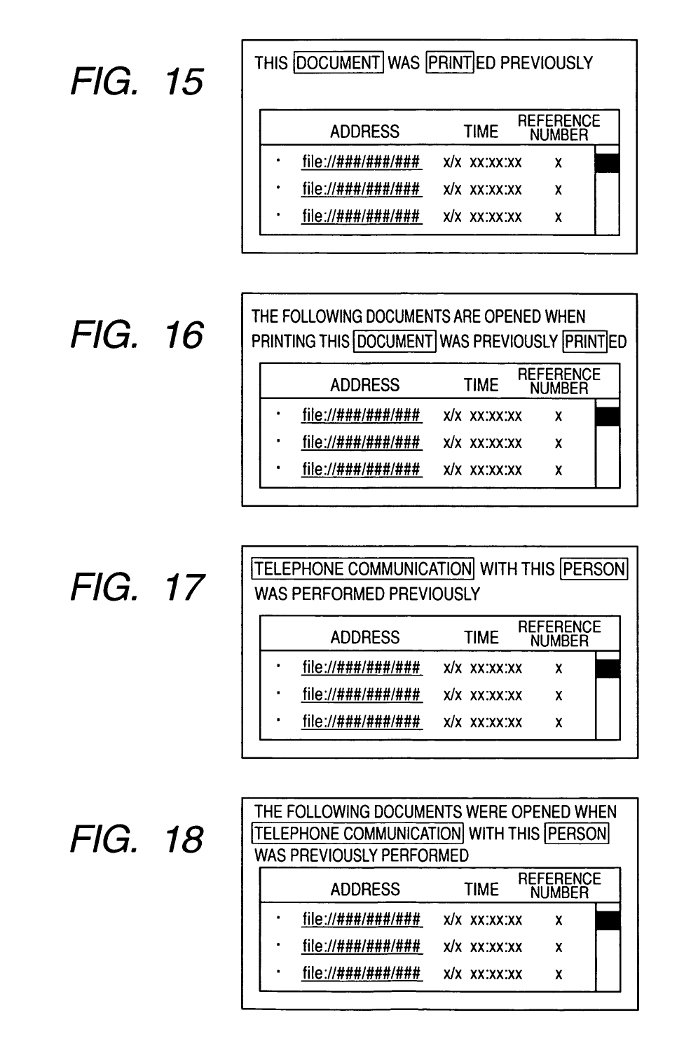

FIG. 15 to FIG. 18 are diagrams for representing executed results of the intelligent supporting process during operation, which are displayed on the display section 106 of the PC 100 by executing the process of step 1417 related to the used document and the target document (entire portion) formed in step 1415.

FIGS. 15 to 18 are diagrams illustrating the process results of the during-activation intellectual assistance process displayed on the display section 106 of the PC 10 by performing step 1417 regarding the utilization documents and target documents (whole) generated at step 1415.

Specifically, FIG. 15 shows a search result associated with the target document specified by performing the during-activation intellectual assistance process (step 711) when an instruction of printing documents data stored in the storage section 108 is given to the recording section 202 of the multifunctional machine 20 from the PC 10 (a PC print operation is performed as the processing operation: see FIG. 3).

That is, when the PC print operation is performed, the document search process (step 1105) is performed on the basis of the target document address as a processing target of the PC print operation. As a result, the time when the target document data as a print target of the print operation were s printed is displayed in the format shown in FIG. 15. In this case, the addresses and the reference numbers in FIG. 15 are displayed to be identical.

FIG. 16 shows a utilization document opened in the period in which the target document data as the present print target was being printed.

For example, when the ID in FIG. 2 is “sid1” (the start time of the record is “11:59:00 on Jul. 15, 2005” and the end time is “12:02:00 on Jul. 15, 2005”) and the document addresses of the utilization documents associated with the target document of sid1 are “file://***/***/d2” and “file://***/***/d3” (in FIG. 4, the time registered in the ID utilizing the document address of the utilization document is “11:50:00 on Jul. 15, 2005” for did2, “12:00:00 on Jul. 15, 2005” for did6, and “12:01:00 on Jul. 15, 2005” for did8) , the documents associated with “file://***/***/d2” and “file://***/***/d3” are opened in the period when the PC print operation associated with sid1 A was being performed. Accordingly, predetermined details associated with the two utilization documents are displayed in the format shown in FIG. 16.

Since step 1417 related to the target document (scan) is executed, executed results of the intelligent supporting process during operation displayed on the display section 106 of the PC 100 are displayed in such a mode approximated to FIG. 16.

Specifically, “when ‘this document (information for specifying target document is displayed) in past’ was scanned, following document was also read” is displayed on an upper stage, and in addition, target documents which are specified by the scanning search process (step 1318) are displayed in a lower stage in an order of the target documents sorted by the search result display process (step 1107).

FIGS. 17 and 18 show display examples when the communication results from the telephone transmission (event “TLT” in FIG. 3) or the telephone reception (event “TLR” in FIG. 3) through the line communication section 2112 of the multifunction machine 20 in step 707) (the course to the display is the same as described above and thus is omitted).

In FIG. 15, since the processing operation is a PC print operation, the GID is “1” (see FIG. 3), and the document search process (step 1105) is performed using the document address as the search condition, the addresses and the reference numbers are identical and only the times are different from each other. However, in case of the telephone transmission or the telephone reception, the GID is “2” (see FIG. 3) and the document search process (step 1105) is performed without using the document address as the search condition. Accordingly, the target document addresses shown in “Address” of FIG. 17 are different from each other.

In the information management system 1 according to the first illustrative aspect, the addresses in FIGS. 15 to 18 are displayed in the hyperlink format (step 1417), and when the hyperlinks are selected using the operation section 104, the document data associated with the address are read from the storage section 108 and are displayed on the display section 106.

(Status Table Registering Process)

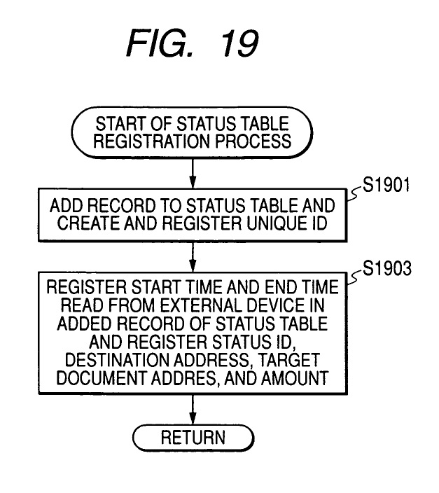

FIG. 19 is a diagram illustrating a flow of a registering process in the status table 1081 shown in FIG. 2.

When the status table registering process is performed in step 715, the control section 100 of the PC 10 additionally creates a unique ID of a record to be registered in the status table 1081. Then, the control section registers the unique ID as an ID of the new record (step 1901) and then performs the process of step 1903.

In step 1903, the time when the activation of the external device is detected in step 707 and the time when the activation end of the external device of which the activation has been detected in step 707 is detected in step 713 are registered as the start time and the end time of the new record in step 1901, respectively, and the status ID, the destination address, the target document address, and the amount, which are input from the external device of which the activation has been detected and stored in the RAM or the like of the control section 100 in step 709 before the during-activation intellectual assistance process (step 711), are similarly registered in the new record in step 1901.

(Manual Intellectual Assistance Process)

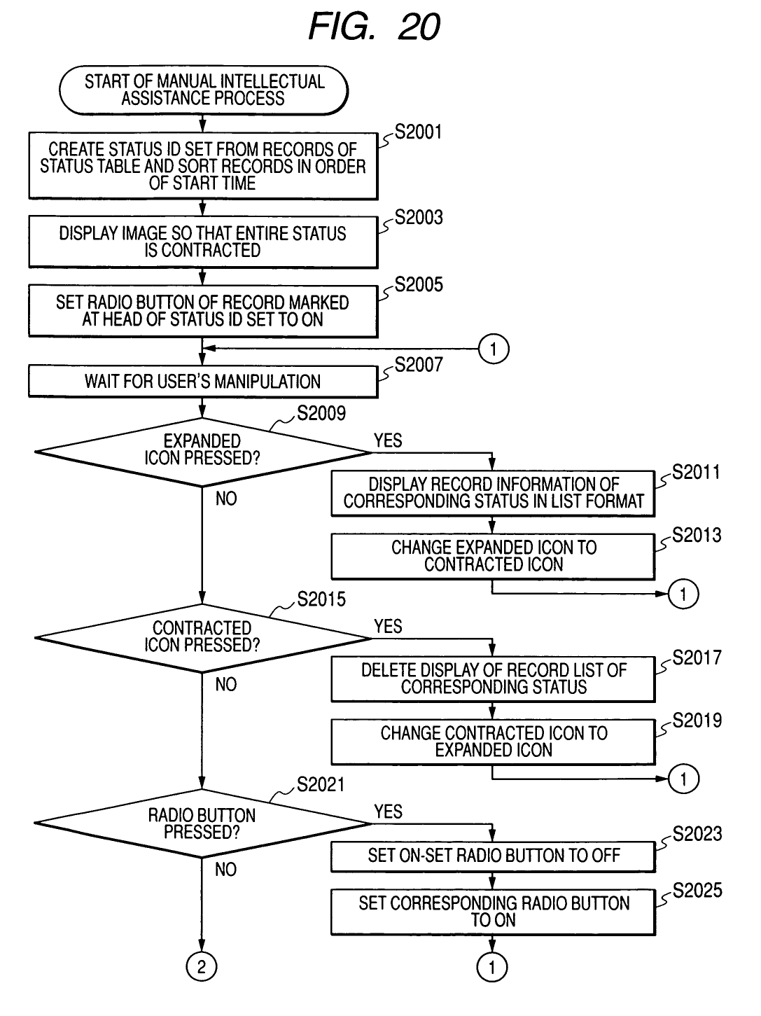

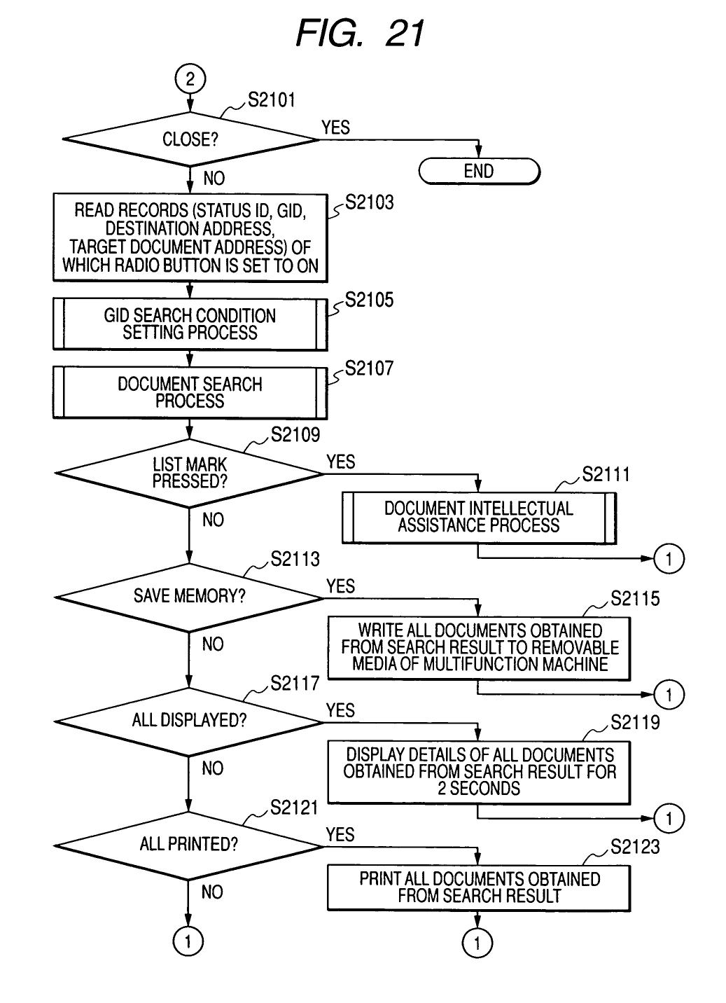

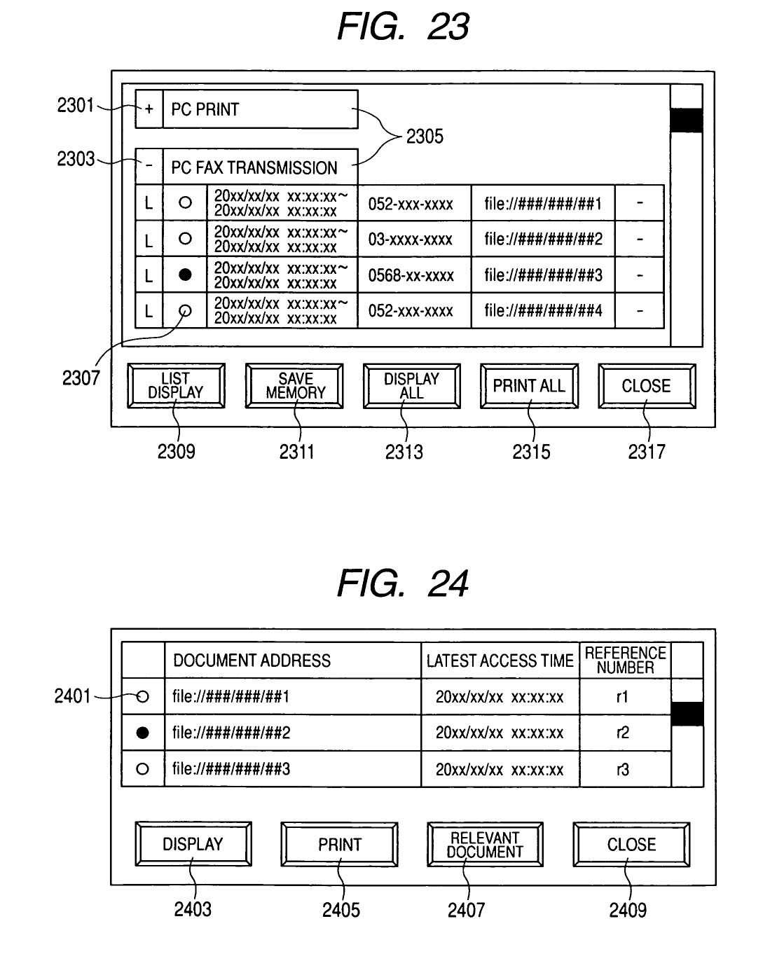

FIGS. 20 and 21 are diagrams illustrating a flow of the manual intellectual assistance process. FIG. 23 is a diagram illustrating a display format of information displayed on the display section 106 of the PC with the performing of the manual intellectual assistance process.

In step 719, with the start of the manual intellectual assistance process, this process starts. This process operates in parallel to the PC main process shown in FIG. 7. That is, the process of step 719 proceeds to the process of step 701 without waiting for the end of the manual intellectual assistance process after the manual intellectual assistance process starts.

The control section 100 of the PC 10 creates a set of status IDs from the records of the status table 1081, performs a process of sorting the records of the set of status IDs in the order of start times (step 2001), and displays the result of the process on the display section 106 of the PC 10 (step 2003).

Here, in step 2003, the entire statuses 2305 are displayed in a contracted format, and specifically, only the titles of the processing operations indicated by the status IDs are displayed (see the display format of the PC print operation in FIG. 23).

In step 2005, in the display format displayed through the process of step 2003, a radio button 2307 (see FIG. 23) of the head record (the record sorted in the head in step 2001) of the status 2305 displayed at the uppermost position (PC print in FIG. 23) is set to ON with the initial setting (step 2005).

In the state in which the processes up to step 2005 are performed after the manual intellectual assistance process starts (step 719), the control section 100 waits until a user manipulates by the use of the operation section 104 (step 2007).

In the wait state (step 2007), when the user input an instruction by the use of the operation section 104, the control section 100 determines whether the instruction is to press an expanded icon 2301 (see FIG. 23) (step 2009).

Here, when the input instruction is to press the expanded icon 2301 (step 2009: YES), the record information of the status 2305 corresponding to the pressed expanded icon 2301 is displayed in a list format in response to the sorting process of step 2001 (step 2011) and the expanded icon 2301 of the expanded status 2305 is changed to a contracted icon 2303 (step 2013).

The processes of steps 2011 and 2013 are specifically described with reference to FIG. 23. In case of the PC fax transmission operation, the status 2305 is displayed along with the expanded icon 2301, similarly to the PC print operation, before the expanded icon 2301 is pressed (step 2009) (in other words, the list (records) is not displayed).

In this state, when the process of step 2009 is performed to the expanded icon 2301 for the PC fax transmission (step 2009: YES), the records of which the status IDs are marked “FPT” in the status table 1081 are displayed in the format shown in FIG. 23 in the sorting order of step 2001 (step 2011), and the expanded icon 2301 associated with the PC fax transmission is changed to the contracted icon 2303 (step 2013: the display is changed from “+” to “−”). At the time of first ending the process of step 2013, the process of step 2005 is valid, and all the radio buttons 2307 are set to OFF in the records other than the record sorted on the top displayed associated with the PC fax transmission.

On the other hand, in the wait state of step 2007, when the input instruction is not to press the expanded icon 2301 (step 2009: NO), but to press the contracted icon 2303 (step 2015: YES), the display in the PC fax transmission format shown in FIG. 23 is changed to the PC print format. That is, the display of the record list of the corresponding status 2305 is erased (step 2017) and the contracted icon 2303 is changed to the expanded icon 2301 (step 2019).

In the wait state of step 2007, when the input instruction is not to press the contracted icon 2303 (step 2015: NO), but to press the radio button 2307 (step 2021: YES), the radio button 2307 set to ON for a predetermined record (the head record of the uppermost status 2305 in the initial state) is changed to OFF (step 2023) and the radio button 2307 corresponding to the user's manipulation is set to ON (step 2025).

After the processes of step 2013, 2019, and 2025 are performed, the control section waits in step 2007 until the user's manipulation is performed.

Here, in the wait state of step 2007, when the instruction input by the user's manipulation is not to press any one of the expanded icon 2301, the contracted icon 2303, and the radio button 2307 (steps 2009, 2015, and 2021: NO), the process shown in FIG. 21 is performed.

That is, the control section 100 of the PC 10 determines whether the instruction input by the user's manipulation is the end of the manual intellectual assistance process, specifically, whether a closing button 2317 is pressed (step 2101). When it is YES (step 2101: YES), the process ends.

On the contrary, when the instruction is not to press the closing button 2317 (step 2101: NO), the instruction is to press a list display button 2309, a memory storage button 2311, an all display button 2313, or an all print button 2315. Accordingly, in order to perform the processes corresponding to the buttons, the records of which the radio button is set to ON (status ID, GID, destination address, target document) are read (step 2103).

The GID search condition setting process (step 2105) and the document search process (step 2107) are performed on the basis of the read information, and then the process of step 2109 is performed. Both processes performed in steps 2105 and 2107 are similar to the GID search condition setting process (step 1103) and the document search process (step 1105) performed in the during-activation intellectual assistance process (step 711), and thus description thereof is omitted.

In step 2109, it is determined whether the instruction which is input through the user's manipulation of the operation section 104 and which results in the performing of the process of step 2103 is to press the list display button 2309.

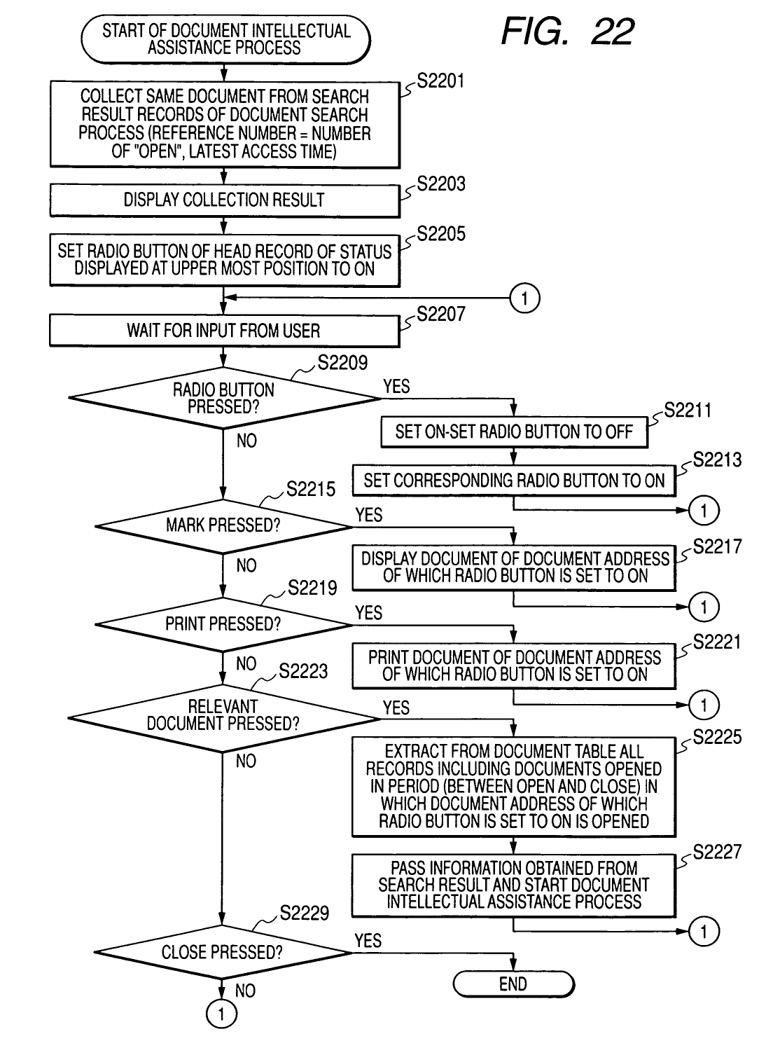

When the instruction is to press the list display button 2309 (step 2109: YES), the document intellectual assistance process is activated by the use of the result of the document search process of step 2107 (step 2111). The details of the document intellectual assistance process are described later with reference to FIG. 22.

On the contrary, when the instruction is not to press the list display button 2309 (step 2109: NO), it is determined whether the instruction is to press the memory storage button 2311 (step 2113). When it is YES (step 2113: YES), the control section 100 instructs the multifunction machine 20 to write the document data of the document address described in the search result record obtained through the document search process (step 2107) to a removable media 2101, and transmits the corresponding document data from the storage section 108 to the multifunction machine 20 through the communication section 102. On the other hand, the control section 200 of the multifunction machine 20 writes the corresponding document data received through the communication section 214 in response to the instruction to the removable media 2101 (step 2115).

When the instruction is not to press the memory storage button 2311 (step 2113: NO), it is determined whether the instruction is to press the all display button 2313 (step 2117) When it is YES (step 2117: YES), the control section 100 opens the document data of the document address described in the search result record obtained through the document search process (step 2107), and sequentially displays the contents on the display section 106 with a predetermined interval of time, for example, 2 seconds (step 2119).

When the instruction is not to press the all display button 2313 (step 2117: NO), it is determined whether the instruction is to press the all print button 2315 (step 2117). When it is YES (step 2117: YES), the control section 100 transits the document data of the document address described in the search result record obtained through the document search process (step 2107) to the multifunction machine 20 through the communication section 102, and allows the recording section 202 of the multifunction machine 20 to print the document data (step 2123).

When the instruction is not to press the all print button 2315 (step 2121: NO), a process corresponding to the press is performed or it is determined that the press is erroneous. Then, the control section waits until the user's manipulation is performed (step 2007).

When the processes of steps 2111, 2115, 2119, and 2123 are finished, the control section waits in step 2007 until the user's input is performed.

FIG. 22 is a diagram illustrating a flow of the document intellectual assistance process started in step 2111. FIG. 24 is a diagram illustrating a display format of information displayed on the display section 106 of the PC 10 at the time of performing the document intellectual assistance process.

First, in step 2201, the control section 100 of the PC 10 collects the number of reference to the document data (the number of records of which the event is “open”) of the same document address and the final access time (time described in the latest record) from the search result records obtained through the document search process (step 2107) by the use of the records comprising the same document address (step 2201), and then performs the process of step 2203.

In step 2203, the collection result is displayed in the format shown in FIG. 24 on the display section 106. At this time, the radio button of the head record among the displayed records is set to ON (step 2205).

Here, in the state in which the processes up to step 2205 are performed after the document intellectual assistance process starts (step 2111), the control section 100 waits until the user manipulates the operation section 104 (step 2207).

In the wait state (step 2207), when the user input an instruction through the operation section 104, the control section 100 determines whether the input instruction is to press the radio button 2401 (see FIG. 24) (step 2209). When it is YES (step 2209: YES), the process of step 2201 is performed.

In step 2207, the radio button 2401 set to ON in a predetermined record (the head record in the initial state) is set to OFF (step 2211) and the radio button 2401 corresponding to the user's manipulation is set to ON (step 2213).

On the other hand, when it is determined in step 2209 that the input instruction is not to press the radio button 2401, it is determined whether the input instruction is to press the display button 2403 (step 2215). When it is YES (step 2215: YES), the process of step 2217 is performed.

In step 2217, the document data of the document address in which the radio button is set to ON is opened and displayed on the display section 106.

When it is determined in step 2215 that the input instruction is not to press the display button 2403, it is determined whether the input instruction is to press the print button 2405 (step 2219). When it is YES (step 2219: YES), the process of step 2221 is performed.

In step 2221, the control section 100 reads the document data of the document address, in which the radio button is set to ON, from the storage section 108 and transmits the document data to the multifunction machine 20 through the communication section 102, and the recording section 202 of the multifunction machine 20 prints the document data.

When it is determined in step 2219 that the input instruction is not to press the print button 2405, it is determined whether the input instruction is to press a relevant document button 2407 (step 2223). When it is YES (step 2223: YES), the process of step 2225 is performed.

Instep 2225, all the records of which the event is “open” in the period (between open and close) when the document data of the document address in which the radio button 2401 is set to ON are opened are extracted from the document table 1081 (step 2225).

Specifically describing the process with reference to FIG. 24, since the document data stored at the document address “file:/###/###/###2” comprises the number of reference of r2, the document data are opened r2 times. Accordingly, the extraction is performed to all the r2 periods.

When the period when the document data of the document address in which the radio button 2401 is set to ON is determined, the identity of the user (operator in FIG. 4) is considered.

The document intellectual assistance process starts again with respect to the search result records obtained through the extraction process of step 2225 (step 2227).

That is, the user can sequentially see documents associated with a document by performing the document intellectual assistance process.

When it is determined in step 2223 that the input instruction is not to press the relevant document button 2407, the control section 100 determines whether the input instruction is to press the closing button 2409 (step 2229). When it is YES (step 2229: YES), the control section ends the document intellectual assistance process (step 2111) and waits in step 2007 until the user's manipulation is performed.

On the other hand, when it is determined that the input instruction is not to press the closing button 2409 (step 2229: NO), the control section performs a process corresponding to the press or determines that the press is erroneous, and waits until the user's manipulation is performed (step 2207).

After performing the processes of steps 2213, 2217, 2221, and 2227, the control section waits again in step 2207 until the user's input is performed.

(Process 2 of Information Management System)

Next, a process (2) of the information management system 1083 comprising the above-mentioned configuration is described with reference to the drawings. The process (2) starts in parallel to the process (1).

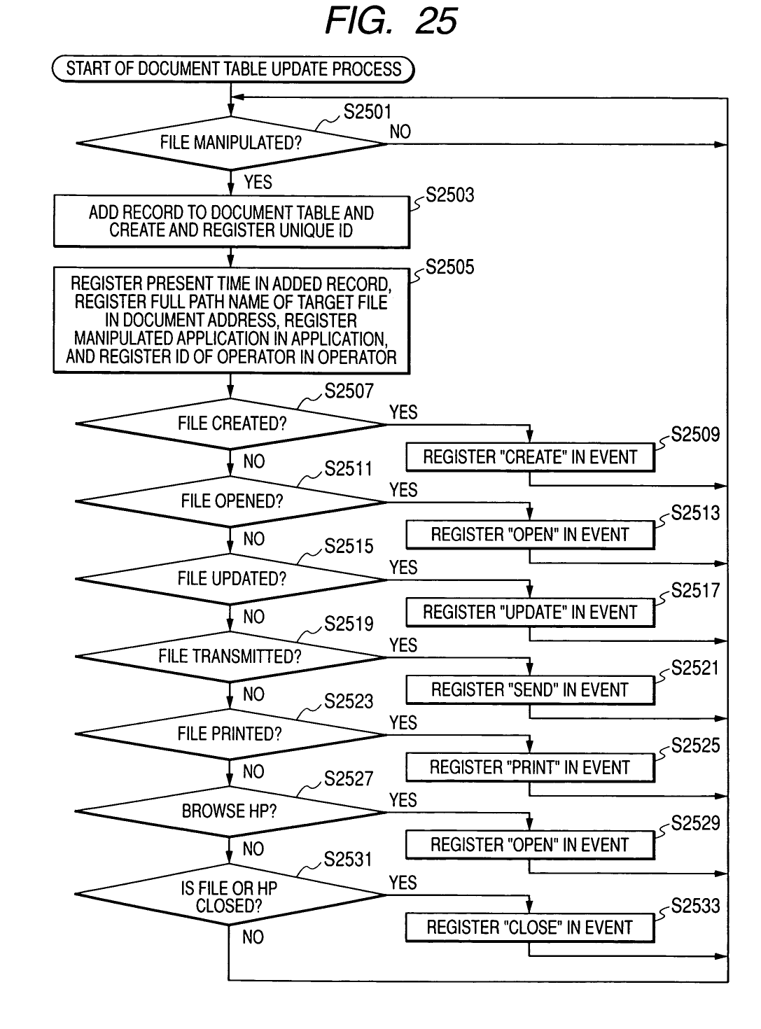

FIG. 25 is a diagram illustrating a flow of a process of updating the document table 1083 performed by the PC 10. The process (2) shown in the flow is performed by the control section 100 of the PC 10, and more specifically, is performed by the CPU of the control section 10 by the use of the program stored in the ROM or the like.

First, when the document data stored in the storage section 108 are manipulated by the use of the operation section 104 or the operation of the multifunction 20 is carried out, that is, when the target document data are transmitted to the PC 10 from the multifunction machine 20 by starting the processing operation (status) described as “(copied to PC)” among the items of the “target document address” of FIG. 3, the target document data are newly stored in the storage section 108, the RFID tags 322 and 324 of the books 32 and 34 are read by the RFID tag reading section 306 of the book sensor 30, and the information is transmitted to the PC 10 through the communication section 34, the control section 100 determines whether a homepage (hereinafter, referred to as “HP”) on Internet 70, which introduces the book 32 or the like associated with the transmission from the book sensor 30, is opened (hereinafter, the manipulations or processes are referred to as “file manipulation”) (step 2501).

When it is determined in step 2501 that the file manipulation is performed (step 2501: YES), the control section 100 adds a record to the document table 1083, creates an ID unique to the record, registers the unique ID (step 2503), and then performs the process of step 2505.

When it is determined in step 2501 that the condition is not satisfied (step 2501: NO), the control section waits until the file manipulation is performed.

In step 2505, the present time is registered to the record added in step 2503, registers an application obtained by preparing a full pass name of the target file with a application to the document address, and registers the type of the operator to the operator.

Thereafter, a process of determining information to be registered to the “event” not yet registered is performed (steps 2507 to 2533).

First, the control section 100 determines whether the file manipulation performed in step 2501 is to store a new document file in the storage section 108 (hereinafter, referred to as “file creation” (step 2507). The control section registers “create” as an event, when the file manipulation is the file creation (step 2507: YES).

On the other hand, when the file manipulation is not the file creation (step 2507: NO), the control section determines whether the file manipulation is to open the document file stored in the storage section 108 (hereinafter, referred to as “file opening”) (step 2511). When it is YES (step 2511: YES), the control section registers “open” as an event (step 2513).

When it is not YES in step 2511 (step 2511: NO), it is determined whether the document data stored in the storage section 108 is updated (overwritten) (step 2515). When it is YES (step 2515: YES), “update” is registered as an event (step 2513).

When it is not YES in step 2515 (step 2515: NO), it is determined whether the document data stored in the storage section 108 is transmitted (the PC fax transmission is comprised) (step 2519). When it is YES (step 2519: YES), “send” is registered as an event (step 2521).

When it is not YES in step 2519 (step 2519: NO), it is determined whether the document data stored in the storage section 108 is printed (which corresponds to the status “PC fax transmission” in FIG. 3) (step 2519). When it is YES (step 2521: YES), “send” is registered as an event (step 2521).

When it is not YES in step 2515 (step 2515: NO), it is determined whether the document data stored in the storage section 108 is printed (the recording section 202 of the multifunction machine 20 is used) (step 2523). When it is YES (step 2523: YES), “print” is registered as an event (step 2525) When it is not YES in step 2523 (step 2523: NO), it is determined whether the HP is opened (step 2527). When it is YES (step 2527: YES), “open” is registered as an event (step 2529).

When it is not YES in step 2527 (step 2527: NO), it is determined whether the file or HP is closed which corresponds to the file opening (step 2511) or the HP opening (step 2527) (step 2531). When it is YES (step 2531: YES), “close” is registered as an event (step 2529).

When it is not YES in step 2531 (step 2531: NO), the control section 100 waits until a file manipulation is performed again, after finishing the process of step 2509, 2513, 2517, 2521, 2525, 2529, or 2533.

Hitherto, the “document data” have been mainly exemplified in the description according to the first illustrative aspect. However, the data as a target of the information management system 1 are not limited to the “document data”, but the same details (processes) may be performed to, for example, “image data”, “sound data”, other data, or mixtures of the data.

### SECOND EXAMPLE

Hereinafter, an information management system different from the first illustrative aspect will be described specifically.

A second illustrative aspect of the invention is different from the first illustrative aspect, in that the “GID” used in the first illustrative aspect is not provided, that is, the “GID” is not defined in FIG. 3 and the “GID search condition setting process” is not performed in the during-activation intellectual assistance process and the manual intellectual assistance process. Therefore, the details of the same configuration and process order are omitted but only differences are described in the following description (since the process order in the manual intellectual assistance process is similar to the during-activation intellectual assistance process, the during-activation intellectual assistance process is substantially described in the second illustrative aspect).

(During-Activation Intellectual Assistance Process)

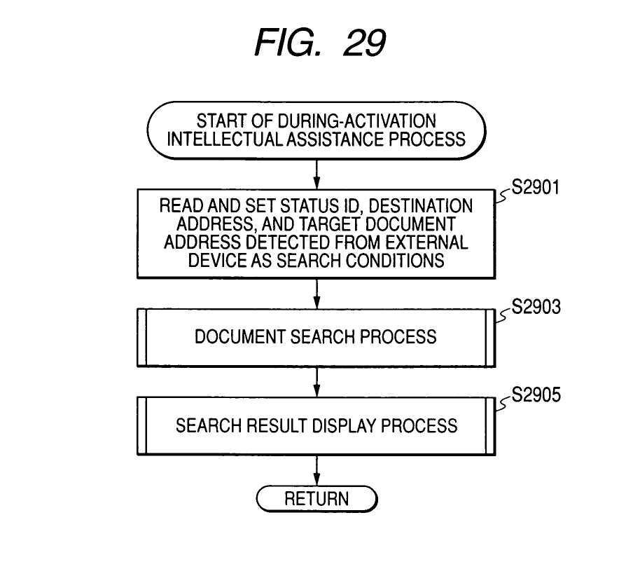

FIG. 29 is a diagram illustrating a flow of the during-activation intellectual assistance process.

When the during-activation intellectual assistance process is performed in step 711 of FIG. 7, the control section 100 of the PC 10 first reads the status ID, the destination address, and the target document address input (detected) by the external device from the RAM in step 709. The control section sets the data selected by the user through the operation section 104 as a search condition (step 2901), and performs the document search process (step 1103).

FIG. 13 is a diagram illustrating a flow of the document search process (step 2903). First, all the records in the status table 1081 and the document table 1083 are set to the initial values of the search result records (step 1301).

Next, in order to specify the target document associated with a specific record from the status table 1081, a search process is performed on the basis of the search condition selected in step 2903.

That is, in step 1303, it is determined whether the status ID is set as the search condition (step 1303). When it is YES (step 1303: YES), the record corresponding to the status ID set as the search condition in the status table 1081 is stored as the search result record (step 1305) and the process of step 1307 is performed. When the status ID is not set as the search condition (step 1303: NO), the process of step 1307 is performed without performing the process of step 1305.

In step 1307, it is determined whether the destination address is added as the search condition. When it is YES (step 1307: YES), the record corresponding to the destination address designated as the search condition among the search result records stored in step 1305 is stored as the search result record (step 1309) and then the process of step 1311 is performed. In step 1307, when the destination address is not added as the search condition (step 1307: NO), the process of step 1311 is performed without performing the process of step 1309.

In step 1311, it is determined whether the target document address is added as the search condition. When it is determined that the target document address is set (step 1311: YES), the record corresponding to the target document address designated as the search condition among the search result records stored in step 1305 and the like is stored as the search result record (step 1313) and then the process of step 1315 is performed. When it is determined in step 1311 that the target document address is not added as the search condition (step 1311: NO), the process of step 1315 is performed without performing the process of step 1313.

Here, the search result records obtained through the processes of steps 1303 to 1313 will be described in more detail.

When it is YES in steps 1303, 1307, and 1311, the search result records comprise the records in the same status table 1081 as being stored in step 1313.

When it is YES in steps 1303 and 1307 and it is NO in step 1311, the search result records comprise the records in the same status table 1081 as being stored in step 1309.

When it is YES in steps 1303 and 1311 and it is NO in step 1307, the search result records comprise the records in the same status table 1081 as being stored in step 1313.

When it is YES in step 1303 and it is NO in steps 1307 and 1311, the search result records comprise the records in the same status table 1081 as being stored in step 1305.

When it is NO in step 1303 and it is YES in steps 1307 and 1311, the search result records comprise the records in the same status table 1081 as being stored in step 1313.

When it is NO in steps 1303 and 1311 and it is YES in step 1307, the search result records comprise the records in the same status table 1081 as being stored in step 1309.

When it is NO in steps 1303 and 1307 and it is YES in step 1311, the search result records comprise the records in the same status table 1081 as being stored in step 1313.

When it is NO in steps 1303, 1307 and 1311, the search result records comprise the records in the same status table 1081 as the status table 1081 set as an initial value in step 1301.

In step 1315, in order to perform the processes subsequent to step 1317, a non-processed search result record is read from the search result records specified in steps 1303 to 1313 and then the process of step 1317 is performed.

The processes after step 1317 are including the search result displaying processing 2105, similar to those of the first illustrative aspect, and thus details thereof are not described.

What is claimed is:

1. An information management system comprising:
an external device having a function performing unit that includes an input unit; and
an information processing device connected to the external device, wherein
the information processing device comprises:
a detection unit that detects a period in which the function performing unit of the external device performs a process;
a specification unit that specifies that the process performed in the period detected by the detection unit corresponds to a reading process of data by the input unit;
a storage unit that correlates and stores the period in which the reading process specified by the specification unit is performed and the data read in the period, and that stores a condition time to relate the data read by the input unit with each other;
a comparing unit that compares (1) a specific time specified by (11) one time instant included in the period and corresponding to execution of one reading process specified by the specification unit and (12) another time instant included in the period and corresponding to the execution of another reading process different from the one reading process, with (2) the condition time stored in the storage unit, in case where the another reading process is specified by the specification unit; and
a correlation giving unit that gives a correlation that (1′) the one reading process or data obtained by the one reading process is correlated with (2′) data obtained by the another reading process, in a case where the specific time is shorter than or equal to the condition time, and wherein
the external device comprises an offer unit that offers the period and information that specifies the process performed in the period in a state where the information processing device detects the process, in a case where the process is performed by the function performing unit.

2. The information management system as claimed in claim 1, wherein
in a case where three or more data are correlated to each other or two or more data obtained by the another reading process are correlated to the one reading process, the correlation giving unit of the information processing device compares at least two specific times specified by (1) one time instant included in the period and corresponding to execution of a reading process with respect to one data among the data correlated to each other or to execution of the one reading process and (2) other time instants included in the period and corresponding to execution of reading processes with respect to data other than the one data or execution of the another reading process with respect to the correlated data, and gives a correlation of a higher degree with respect to a data correlation that the specific time becomes shorter.

3. The information management system as claimed in claim 2, wherein
the information processing device comprises:
an output unit that outputs information which specifies the data correlated by the correlation giving unit; and
an output control unit that output data, to which the correlation giving unit gives a correlation of a higher degree, in a higher priority, in a case where information that specifies the correlated data is outputted to the output unit.

4. An information management system comprising:
an external device having a function performing unit that includes an input unit; and
an information processing device connected to the external device, wherein
the information processing device comprises:
a detection unit that detects a period in which the function performing unit of the external device performs a process;
a specification unit that specifies that the process performed in the period detected by the detection unit corresponds to a reading process of data by the input unit;
a storage unit that correlates and stores the period in which the reading process specified by the specification unit is performed and the data read in the period, that stores a condition degree in which time is defined as an element and a degree of relevance of data read by the input unit decreases as a length of the time increases, and that stores a condition degree which is employed to correlate the data read by the input unit;
a relevance acquiring unit that acquires a degree of relevance from the condition relationship stored in the storage unit, employing a specific time specified by (1) one time instant included in the period and corresponding to execution of one reading process, and (2) another time instant included in the period and corresponding to execution of the another reading process different from the one reading process, in a case where the another reading process is specified by the specification unit;
a comparing unit that compares the degree of relevance acquired by the relevance acquiring unit with the condition degree stored in the storage unit; and
a correlation giving unit that gives a correlation that (1′) the one reading process or data obtained by the one reading process is correlated with (2′) data obtained by the another reading process, in a case where the degree of relevance acquired by the relevance acquiring unit is higher than or equal to the condition degree, and wherein
the external device comprises an offer unit that offers the period and information that specifies the process performed in the period in a state where the information processing device detects the process, in a case where the process is performed by the function performing unit.

5. An information processing device connected to an external device, which comprises: a function performing unit that includes an input unit; and an offer unit that offers a period and information that specifies a process performed in the period in a state where the information processing device detects the process, in a case where the process is performed by the function performing unit, the information processing device comprising:
a detection unit that detects the period in which the function performing unit of the external device performs the process;
a specification unit that specifies that the process performed in the period detected by the detection unit corresponds to a reading process of data by the input unit;
a storage unit that correlates and stores the period in which the reading process specified by the specification unit is performed and the data read in the period, and that stores a condition time to relate the data read by the input unit with each other;
a comparing unit that compares (1) a specific time specified by (11) one time instant included in the period and corresponding to execution of one reading process specified by the specification unit and (12) another time instant included in the period and corresponding to the execution of another reading process different from the one reading process, with (2) the condition time stored in the storage unit, in case where the another reading process is specified by the specification unit; and
a correlation giving unit that gives a correlation that (1′) the one reading process or data obtained by the one reading process is correlated with (2′) data obtained by the another reading process, in a case where the specific time is shorter than or equal to the condition time.

6. A computer usable medium that stores a program of instructions executable by a computer to perform a function for processing information, the computer being connected to an external device, which comprises: a function performing unit that includes an input unit; and an offer unit that offers a period and information that specifies a process performed in the period in a state where the process is detected, in a case where the process is performed by the function performing unit, the function comprising the steps of:
detecting the period in which the function performing unit of the external device performs the process;
specifying that the process performed in the period detected corresponds to a reading process of data by the input unit;
correlating and storing the period in which the reading process specified is performed and the data read in the period, and that stores a condition time to relate the data read by the input unit with each other;
comparing (1) a specific time specified by (11) one time instant included in the period and corresponding to execution of one reading process specified and (12) another time instant included in the period and corresponding to the execution of another reading process different from the one reading process, with (2) the condition time stored, in case where the another reading process is specified; and
giving a correlation that (1′) the one reading process or data obtained by the one reading process is correlated with (2′) data obtained by the another reading process, in a case where the specific time is shorter than or equal to the condition time.
